(19) United States
(12) Patent Application Publication
(10) Pub. No.: US 2019/0301579 A1
(43) Pub. Date: Oct. 3, 2019

(54) IMPELLER ASSEMBLY FOR HYDROKINETIC TORQUE CONVERTER, AND METHOD FOR MAKING THE SAME

(71) Applicant: VALEO KAPEC CO., LTD., Daegu (KR)

(72) Inventors: Xuexian YIN, Troy, MI (US); Alexandre DEPRAETE, Bloomfield, MI (US); Patrick DURHAM, Troy, MI (US)

(21) Appl. No.: 15/938,964

(22) Filed: Mar. 28, 2018

(51) Int. Cl. F16H 41/28; F16H 41/04; B33Y 10/00; B33Y 80/00; B29C 64/10; B33Y 70/00

(52) U.S. Cl. CPC F16H 41/28; F16H 41/04; B33Y 10/00; B29L 2031/7504; B29C 64/10; B33Y 70/00; B33Y 80/00

(57) ABSTRACT

An impeller assembly for a hydrokinetic torque converter. The impeller assembly is rotatable about a rotational axis and comprises an annular impeller wheel coaxial with the rotational axis, and an annular impeller hub made of metallic material and non-rotatably coupled to the impeller wheel. The impeller wheel is made of polymeric material as a single-piece component including an annular impeller shell member and a plurality of turbine blade members axially inwardly extending from the impeller shell member.

### BACKGROUND OF THE INVENTION

### 1. Field of the Invention

The present invention generally relates to fluid coupling devices, and more particularly to an impeller assembly for hydrokinetic torque converters that includes a polymeric impeller wheel, and a method for making the same.

### 2. Background of the Invention

Typically, a hydrokinetic torque converter includes an impeller wheel, a turbine wheel, a stator (or reactor) fixed to a casing of the torque converter, and a one-way clutch for restricting rotational direction of the stator to one direction. The turbine wheel is integrally or operatively connected with a turbine hub linked in rotation to a driven shaft, which is itself linked to an input shaft of a transmission of a vehicle. The casing of the torque converter generally includes a front cover and an impeller shell which together define a fluid filled chamber. Impeller blades are fixed to an impeller shell within the fluid filled chamber to define the impeller wheel. The turbine wheel and the stator are also disposed within the chamber, with both the turbine wheel and the stator being relatively rotatable with respect to the front cover and the impeller wheel. The impeller wheel includes the impeller shell with a plurality of impeller blades fixed to one side of the impeller shell. The turbine wheel includes a turbine shell with a plurality of turbine blades fixed to one side of the turbine shell facing the impeller blades of the impeller wheel.

The turbine wheel works together with the impeller wheel, which is linked in rotation to the casing that is linked in rotation to a driving shaft driven by an internal combustion engine. The stator is interposed axially between the turbine wheel and the impeller wheel, and is mounted so as to rotate on the driven shaft with the interposition of the one-way clutch.

Conventionally, the impeller shell and the impeller blades are formed separately by stamping from steel blanks. The impeller shell is typically slotted to receive, through the slots, tabs formed on the impeller blades. After the impeller blades are located within the impeller shell, the tabs are bent or rolled over to form a mechanical attachment on the impeller shell that holds the impeller blades fixed in position. Similarly, the turbine shell and the turbine blades are generally formed separately by stamping from steel blanks. The turbine shell is typically slotted to receive, through the slots, tabs formed on the turbine blades. After the turbine blades are located within the turbine shell, the tabs are bent or rolled over to form a mechanical attachment on the turbine shell that holds the turbine blades fixed in position.

Current hydrokinetic torque converters and methods for assembly thereof are quite complex, cumbersome and expensive. Therefore, while conventional hydrokinetic torque converters, including but not limited to those discussed above, have proven to be acceptable for vehicular driveline applications and conditions, improvements that may enhance their performance and cost are possible.

### BRIEF SUMMARY OF THE INVENTION

According to a first aspect of the invention, there is provided an impeller assembly for a hydrokinetic torque converter. The impeller assembly is rotatable about a rotational axis and comprises an annular impeller wheel coaxial with the rotational axis, and an annular impeller hub made of metallic material and non-rotatably coupled to the impeller wheel. The impeller wheel is made of polymeric material as a single-piece component including an annular impeller shell member and a plurality of turbine blade members axially inwardly extending from the impeller shell member.

According to a second aspect of the present invention, there is provided a hydrokinetic torque converter comprising a casing rotatable about a rotational axis, an impeller assembly, and a turbine assembly coaxially aligned with and operatively fluidly coupled to the impeller assembly. The impeller assembly comprises an annular impeller wheel non-movably attached to the casing and coaxial with the rotational axis, and an impeller hub integral with the casing and non-rotatably coupled to the impeller wheel. The impeller wheel is made of polymeric material as a single-piece component including an annular impeller shell member and a plurality of turbine blade members axially inwardly extending from the impeller shell member. The impeller hub is made of metallic material.

According to a third aspect of the present invention, there is provided a method for manufacturing an impeller assembly of a hydrokinetic torque converter. The method comprises the step of providing an impeller hub made of metallic material, providing an impeller wheel manufactured by an additive manufacturing process as a single-piece component from a polymeric material, and non-rotatably coupling the impeller wheel to the impeller hub. The method of making the impeller wheel includes the steps of sequentially depositing a plurality of successive layers of the polymeric material in a configured pattern corresponding to the shape of the impeller wheel including an annular impeller shell member and a plurality of impeller blade members unitarily formed with the impeller shell member and axially extending from the impeller shell member, and selectively fusing each layer prior to deposition of the subsequent layer so as to form the impeller wheel.

Other aspects of the invention, including apparatus, devices, systems, converters, processes, and the like which constitute part of the invention, will become more apparent upon reading the following detailed description of the exemplary embodiments.

### BRIEF DESCRIPTION OF THE SEVERAL VIEWS OF THE DRAWING(S)

The accompanying drawings are incorporated in and constitute a part of the specification. The drawings, together with the general description given above and the detailed description of the exemplary embodiments and methods given below, serve to explain the principles of the invention. The objects and advantages of the invention will become apparent from a study of the following specification when viewed in light of the accompanying drawings, in which like elements are given the same or analogous reference numerals and wherein:

FIG. 1 is a fragmented half-view in axial section of a hydrokinetic torque-coupling device in accordance with a first exemplary embodiment of the present invention;

FIG. 2 is a sectional view of an impeller assembly in accordance with the first exemplary embodiment of the present invention;

FIG. 3 is a sectional view of the turbine assembly in accordance with the exemplary embodiment of the present invention;

FIG. 4 is a fragmented half-view in axial section of a hydrokinetic torque-coupling device in accordance with a second exemplary embodiment of the present invention;

FIG. 5 is a sectional view of an impeller assembly in accordance with the second exemplary embodiment of the present invention;

FIG. 6 is a fragmented half-view in axial section of a hydrokinetic torque-coupling device in accordance with a third exemplary embodiment of the present invention;

FIG. 7 is a sectional view of an impeller assembly in accordance with the third exemplary embodiment of the present invention;

FIG. 8 is a fragmented half-view in axial section of a hydrokinetic torque-coupling device in accordance with a fourth exemplary embodiment of the present invention;

FIG. 9 is a sectional view of an impeller assembly in accordance with the fourth exemplary embodiment of the present invention;

FIG. 10 is a fragmented half-view in axial section of a hydrokinetic torque-coupling device in accordance with a fifth exemplary embodiment of the present invention;

FIG. 11 is a sectional view of an impeller assembly in accordance with the fifth exemplary embodiment of the present invention;

FIG. 12 is a fragmented half-view in axial section of a hydrokinetic torque-coupling device in accordance with a sixth exemplary embodiment of the present invention;

FIG. 13 is a sectional view of an impeller assembly in accordance with the sixth exemplary embodiment of the present invention; and

FIG. 14 is a half-view in axial section of a casing of the hydrokinetic torque-coupling device in accordance with the sixth exemplary embodiment of the present invention.

### DETAILED DESCRIPTION OF EXEMPLARY EMBODIMENT(S) AND EMBODIED METHOD(S) OF THE INVENTION

Reference will now be made in detail to exemplary embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in connection with the exemplary embodiments and methods.

This description of exemplary embodiments is intended to be read in connection with the accompanying drawings, which are to be considered part of the entire written description. In the description, relative terms such as “horizontal,” “vertical,” “up,” “down,” “upper”, “lower”, “right”, “left”, “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. The term “integral” (or “unitary”) relates to a part made as a single-piece part, or a part made of separate components fixedly (i.e., non-movably) connected together. Additionally, the word “a” and “an” as used in the claims means “at least one” and the word “two” as used in the claims means “at least two”.

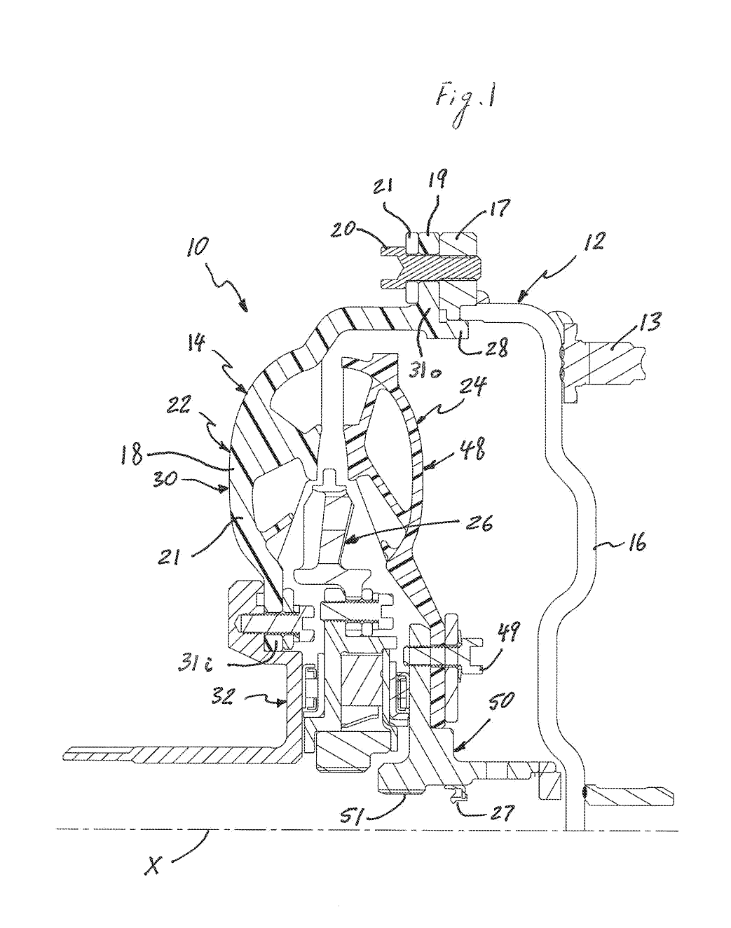

A first exemplary embodiment of a hydrokinetic torque-coupling device is generally represented in FIG. 1 by reference numeral 10. The hydrokinetic torque-coupling device 10 is intended to couple driving and driven shafts, for example of a motor vehicle. In this case, the driving shaft is an output shaft of an internal combustion engine of the motor vehicle and the driven shaft is connected to an automatic transmission (not shown) of the motor vehicle.

The hydrokinetic torque-coupling device 10 comprises a sealed casing 12 filled with a fluid, such as oil or transmission fluid, and rotatable about a rotational axis X, and a hydrokinetic torque converter 14 disposed in the casing 12. The sealed casing 12 and the torque converter 14 are both rotatable about the rotational axis X. The drawings discussed herein show half-views, that is, a cross-section of the portion or fragment of the hydrokinetic torque-coupling device 10 above rotational axis X. As is known in the art, the torque-coupling device 10 is symmetrical about the rotational axis X. Hereinafter the axial and radial orientations are considered with respect to the rotational axis X of the torque-coupling device 10. The relative terms such as “axially,” “radially,” and “circumferentially” are with respect to orientations parallel to, perpendicular to, and circularly around the rotational axis X, respectively.

The sealed casing 12 according to the first exemplary embodiment as illustrated in FIG. 1 includes a first casing shell 16, and a second casing shell 18 disposed coaxially with and axially opposite to the first casing shell 16. Moreover, the first casing shell 16 has a first connector flange 17 integral with (i.e., non-movably attached to) and extending radially outwardly from the first casing shell 16, while the second casing shell 18 has a second connector flange 19 integral with and extending radially outwardly from the second casing shell 18. The first and second casing shells 16, 18 are non-movably (i.e., fixedly) interconnected and sealed together about their outer peripheries, such as by threaded fasteners 20, e.g. screws or bolts, or other mechanical fasteners. Specifically, the threaded fasteners 20 non-movably secure the first connector flange 17 of the first casing shell 16 to the second connector flange 19 of the second casing shell 18 through washers 21. The second casing shell 18 also has an integral support flange 28 extending axially outwardly toward the first casing shell 16. The support flange 28 of the second casing shell 18 is configured to radially support and center the first casing shell 16 with respect to the second casing shell 18.

The second casing shell 18 is non-movably (i.e., fixedly) connected to the driving shaft, more typically to a flywheel (not shown) that is non-rotatably fixed to the driving shaft, so that the casing 12 turns at the same speed at which the engine operates for transmitting torque. Specifically, the casing 12 is rotatably driven by the internal combustion engine and is non-rotatably coupled to the flywheel thereof, such as with studs 13. As shown in FIG. 1, the studs 13 are fixedly secured, such as by welding, to the first casing shell 16. Each of the first and second casing shells 16, 18 are integral or one-piece and may be made, for example, by press-forming one-piece metal sheets.

The torque converter 14 comprises an impeller assembly (sometimes referred to as the pump or impeller) 22, a turbine assembly (sometimes referred to as the turbine) 24, and a stator assembly (sometimes referred to as the reactor) 26 interposed axially between the impeller assembly 22 and the turbine assembly 24. The impeller assembly 22, the turbine assembly 24, and the stator assembly 26 are coaxially aligned with one another and the rotational axis X. The impeller assembly 22, the turbine assembly 24, and the stator assembly 26 are all rotatable about the rotational axis X. The impeller assembly 22, the turbine assembly 24, and the stator assembly 26 collectively form a torus. The impeller assembly 22 and the turbine assembly 24 may be fluidly coupled to one another in operation as known in the art.

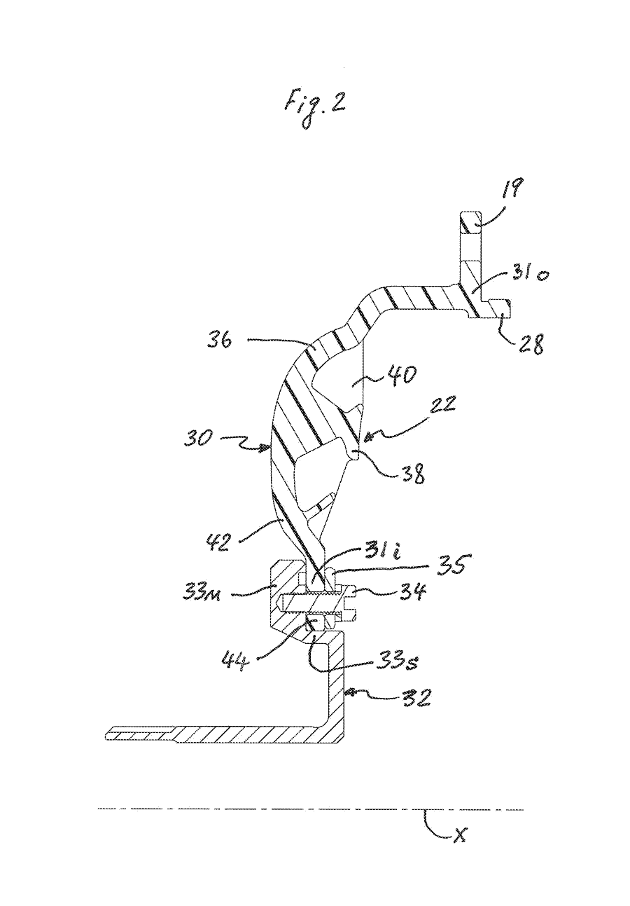

The impeller assembly 22 includes a substantially annular impeller wheel 30 and an impeller hub 32 non-movably (i.e., fixedly) secured to the impeller wheel 30 by threaded fasteners 34, e.g. screws or bolts, or other mechanical fasteners, through a metal (such as steel) ring 35. The impeller hub 32 is arranged for engagement with a hydraulic pump of the transmission. In turn, the impeller wheel 30, as best shown in FIG. 2, comprises a substantially annular, semi-toroidal (or concave) impeller shell member 36, a substantially annular impeller core ring member 38, and a plurality of impeller blade members 40 axially extending between the impeller shell member 36 and the impeller core ring member 38. Alternatively, the impeller wheel 30 does not include the impeller core ring member 38, only the impeller blade members 40 extend axially inwardly from the turbine shell member 36. Thus, a portion of the second casing shell 18 of the casing 12 also forms and serves as the impeller shell member 36 of the impeller wheel 30. Accordingly, the impeller shell member 36 sometimes is referred to as part of the casing 12. The impeller assembly 22, including the impeller wheel 30 and the impeller hub 32, is non-rotatably secured to the first casing shell 16 and hence to the drive shaft (or flywheel) of the engine to rotate at the same speed as the engine output. The impeller hub 32 has an annular, generally axially extending guiding flange 33_{S} and an annular, generally radially extending mounting flange 33_{M}. The guiding flange 33_{S} of the impeller hub 32 is configured to radially support and center the impeller wheel 30 with respect to the impeller hub 32.

The impeller wheel 30 has a radially outer end 31o and a radially inner end 31i. As best shown in FIG. 1, the radially outer end 31o of the impeller wheel 30 is non-movably attached to the first casing shell 16 by the threaded fasteners 20, e.g. screws or bolts, or other mechanical fasteners, while the radially inner end 31i of the impeller wheel 30 is non-movably attached to the impeller hub 32 by the threaded fasteners 34, e.g. screws or bolts, or other mechanical fasteners.

The impeller core ring member 38 and the impeller blade members 40 are formed unitary with the impeller shell member 36. Specifically, according to the first exemplary embodiment as best shown in FIG. 2, the impeller wheel 30 is manufactured as a single-piece component by an additive manufacturing (AM) process, such as 3D printing. Examples of the additive manufacturing process also include selective laser sintering (SLS) (technique that uses a laser as the power source to sinter powdered material (typically nylon/polyamide)), selective laser melting (SLM) (technique that uses a high power-density laser as the power source to melt and fuse material), fused deposition modeling (FDM) (works on an “additive” principle by laying down material in layers), and stereolithography (SLA; also known as stereolithography apparatus, optical fabrication, photo-solidification, or resin printing) which is a form of 3-D printing technology used for creating models, prototypes, patterns, and production parts in a layer by layer fashion using photo-polymerization, a process by which light causes chains of molecules to link, forming polymers, etc.

Typically, a method of additive manufacturing of a three-dimensional article includes the steps of sequentially depositing a plurality of successive layers in a configured pattern corresponding to the shape of the article, and selectively sintering or otherwise fusing the deposited material of each layer prior to deposition of the subsequent layer so as to form the article. Thus, each layer is formed by dispensing at least one material to form an uncured layer, and curing/sintering/fusing the uncured layer. Exemplary additive manufacturing processes are disclosed in U.S. Pat. Nos. 9,751,260, 9,738,031, 9,688,021, 9,555,475, 9,505,171, 9,597,730, 9,248,611, 9,144,940, 6,042,774, 5,753,274, and US Patent Publication No. 2013/0171434, 2012/0139167, 2010/0047470, 2008/0032083, the complete disclosures of which are incorporated herein by reference.

According to the first exemplary embodiment of the present invention, the impeller hub 32 is made of metallic material (or metal), such as steel, while the impeller wheel 30 is made of polymeric material (or polymer) including technical plastics, such as polyether ether ketone (PEEK) thermoplastic polymer (an organic thermoplastic polymer in the polyaryletherketone (PAEK) family), nylon and carbon fibers (e.g., Carbon Fiber CFF™), and resins, such as PLASTCure Rigid, etc. PEEK polymer, for example, provides fatigue and chemical resistance, can operate at high temperatures and retains outstanding mechanical properties at continuous-use temperatures of up to 240° C. (464° F.), allowing it to replace metal even in the most severe end-use environments. Moreover, the technical plastics and resins have a volumetric mass density lower than that of steel.

Accordingly, the additive manufacturing process of making the impeller wheel 30 allows one to optimize the profile and thickness of the turbine shell member 36, the turbine core ring member 38 and/or the turbine blade members 40 for better hydraulic and other performance. In other words, the impeller wheel 30 made by the additive manufacturing process from polymeric material can have variations in thickness, and may be formed in very particular forms and shapes. Also, the turbine assembly can have integral reinforcing ribs. Thus, with the impeller wheel 30 of the present invention there is a possibility for mass optimization by putting the thickness where it is needed for strength and reducing the thickness where it is not needed and thus reducing weight, where stress and deformation are low.

Moreover, the impeller shell member 36, as best shown in FIG. 2, includes a substantially annular, semi-toroidal (or concave) impeller shell portion 42 and an impeller flange portion 44, radially inwardly extending from the impeller shell portion 42. The impeller shell member 36 of the impeller wheel 30 is non-movably (i.e., fixedly) secured to the mounting flange 33_{M} of the impeller hub 32 by the threaded fasteners 34 or other mechanical fasteners extending through openings in the impeller flange portion 44 and the steel ring 35 (as best shown in FIG. 2). In other words, the impeller wheel 30, made of polymeric material, is non-movably (i.e., fixedly) secured to the impeller hub 32, made of metallic material.

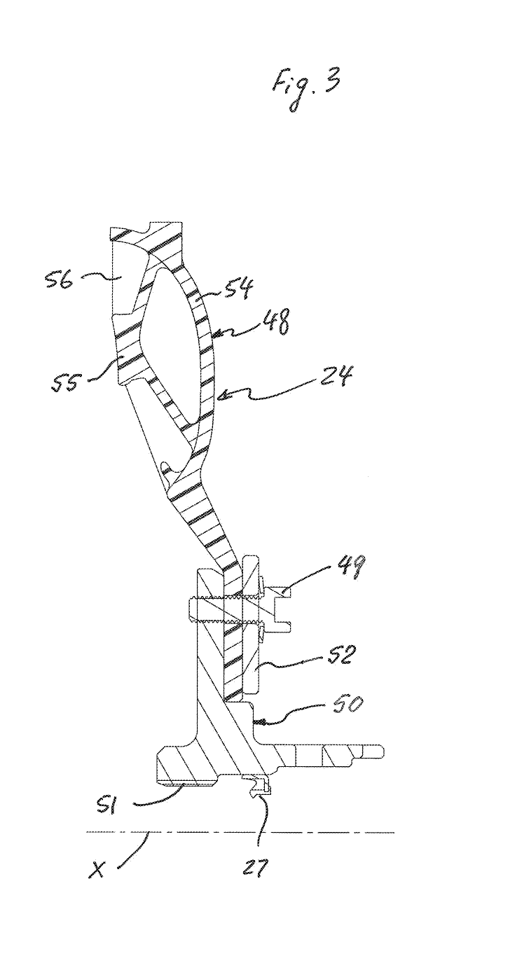

The turbine assembly 24 of the torque converter 14 includes a substantially annular turbine wheel 48, and a substantially annular turbine (or output) hub 50 (as best shown in FIG. 3) rotatable about the rotational axis X and non-movably (i.e., fixedly) secured to the turbine wheel 48 by threaded fasteners 49, e.g. screws or screws, or other mechanical fasteners, through a metal (such as steel) ring 52. The turbine hub 50 is made of a metallic material (or metal), such as steel. The turbine hub 50 has internal splines 51 and is non-rotatably coupled to the driven shaft, such as an input shaft of the automatic transmission of the motor vehicle, which is provided with complementary external splines. Alternatively, a weld or other connection may be used to fix (i.e., non-movably secure) the turbine hub 50 to the driven shaft. The turbine hub 50 is rotatable about the rotational axis X and is coaxial with the driven shaft to center the turbine wheel 48 on the driven shaft. A sealing member 27 (shown in FIG. 1), mounted to a radially inner peripheral surface of the turbine hub 50, creates a seal at the interface of the transmission input shaft and the turbine hub 50.

Furthermore, the turbine wheel 48 of the turbine assembly 24, as best shown in FIG. 1, comprises a substantially annular turbine shell member 54, a substantially annular turbine core ring member 55, and a plurality of turbine blade members 56 axially extending between the turbine shell member 54 and the turbine core ring member 55. The turbine blades 56 outwardly extend from the turbine shell member 54 so as to face the impeller blades 40 of the impeller wheel 30.

The turbine core ring member 55 and the turbine blade members 56 are formed unitary with the turbine shell member 54. Specifically, according to the exemplary embodiment as best shown in FIG. 3, the turbine wheel 48 is manufactured as a single-piece component by an additive manufacturing process. Examples of additive manufacturing processes include selective laser sintering (SLS) (technique that uses a laser as the power source to sinter powdered material (typically nylon/polyamide)), selective laser melting (SLM) (technique that uses a high power-density laser as the power source to melt and fuse material), fused deposition modeling (FDM) (works on an “additive” principle by laying down material in layers), and stereolithography (SLA; also known as stereolithography apparatus, optical fabrication, photo-solidification, or resin printing) which is a form of 3-D printing technology used for creating models, prototypes, patterns, and production parts in a layer by layer fashion using photo-polymerization, a process by which light causes chains of molecules to link, forming polymers, etc.

According to the exemplary embodiment of the present invention, the turbine wheel 48 is made of a polymeric material (or polymer) including technical plastics, such as polyether ether ketone (PEEK) thermoplastic polymer (an organic thermoplastic polymer in the polyaryletherketone (PAEK) family), nylon and carbon fibers (e.g., Carbon Fiber CFF™) and resins, such as PLASTCure Rigid, etc. PEEK polymer, for example, provides fatigue and chemical resistance, can operate at high temperatures and retains outstanding mechanical properties at continuous-use temperatures of up to 240° C. (464° F.), allowing it to replace metal even in the most severe end-use environments. Moreover, the technical plastics and resins have a volumetric mass density lower than that of steel.

Accordingly, use of an additive manufacturing process for making the turbine wheel 48 allows the manufacturer to optimize the profile and thickness of the turbine shell member 54, the turbine core ring member 55 and/or the turbine blade members 56 for better hydraulic and other performance. In other words, a turbine wheel 48 made by an additive manufacturing process from polymeric material can have variations in thickness, and can be formed in very particular forms and shapes. Also, the turbine assembly can have reinforcing ribs. Thus, with the turbine wheel 48 of the present invention there is a possibility for mass optimization by putting the thickness where it is needed for strength and reducing the thickness where it is not needed and thus reducing weight, where stress and deformation are low.

An exemplary method for assembling the hydrokinetic torque-coupling device 10 according to the first exemplary embodiment will now be explained. It should be understood that this exemplary method may be practiced in connection with the other embodiments described herein. This exemplary method is not the exclusive method for assembling the hydrokinetic torque coupling devices described herein. While the method for assembling the hydrokinetic torque-coupling device 10 may be practiced by sequentially performing the steps as set forth below, it should be understood that the methods may involve performing the steps in different sequences.

The turbine assembly 24 and the stator 26 of the torque converter 14 may each be preassembled, as shown in FIG. 1. The impeller wheel 30 is made of polymeric material, such as plastic, resin, etc, by the additive manufacturing process. The polymeric materials used in making the impeller wheel 30 include technical plastics, such as PEEK, nylon and carbon fibers, and resins, such as PLASTCure Rigid, etc. Moreover, the impeller wheel 30 is manufactured as a single-piece component by an additive manufacturing process, such as SLS, SLM, FDM, SLA, etc. Then, the impeller hub 32, made of metallic material, such as steel, is provided. Next, the impeller wheel 30 is mounted on the guiding flange 33_{S} of the impeller hub 32, and the impeller shell member 36 of the impeller wheel 30 is non-movably (i.e., fixedly) secured to the impeller hub 32 by appropriate means, such as by screws 34 or other mechanical fasteners, or by welding, so as to form the impeller assembly 22.

Then, the impeller assembly 22, the turbine assembly 24 and the stator 26 are assembled together to form the torque converter 14, as best shown in FIG. 1. After that, the first casing shell 16 is sealingly fixed to the second casing shell 18 of the casing 12, such as by welding or via threaded fasteners 20 or other mechanical fasteners, so that the torque converter 14 is sealed within the casing 12, as best shown in FIG. 1.

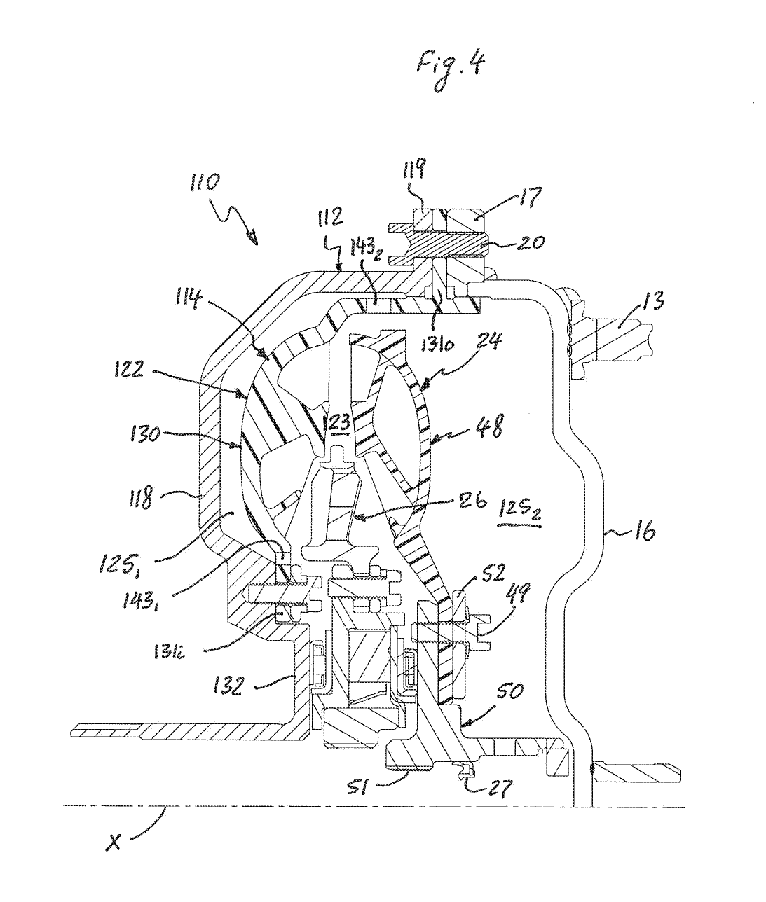

Various modifications, changes, and alterations may be practiced with the above-described embodiment, including but not limited to the additional embodiments shown in FIGS. 4-13. In the interest of brevity, reference characters in FIGS. 4-13 that are discussed above in connection with Figs. FIGS. 1-3 are not further elaborated upon below, except to the extent necessary or useful to explain the additional embodiments of FIGS. 4-13. Modified components and parts are indicated by the addition of a hundred digits to the reference numerals of the components or parts.

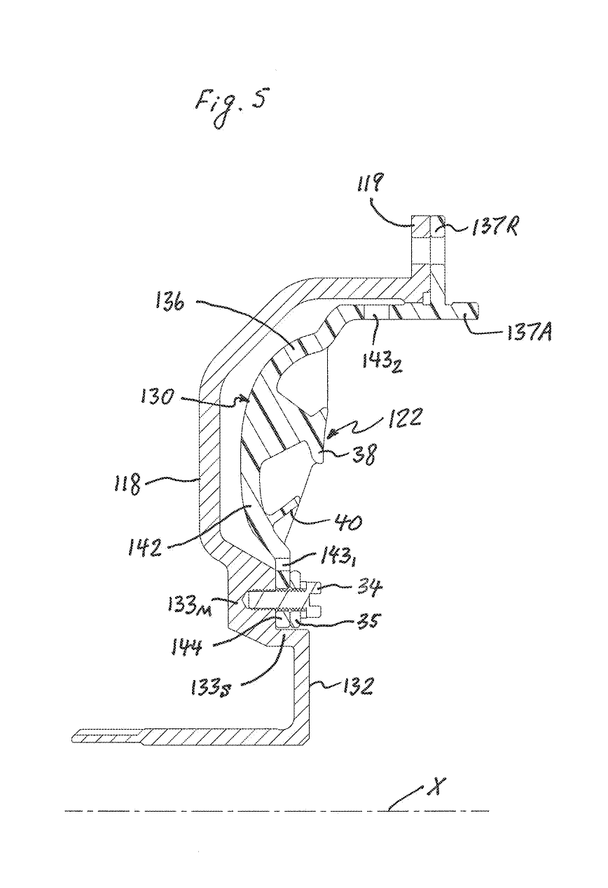

In a hydrokinetic torque-coupling device 110 of a second exemplary embodiment illustrated in FIGS. 4 and 5, the impeller assembly 22 of the first exemplary embodiment is replaced by an impeller assembly 122. The hydrokinetic torque-coupling device 110 of FIGS. 4 and 5 corresponds substantially to the hydrokinetic torque-coupling device 10 of FIGS. 1-3, and portions, which differ, will therefore be explained in detail below.

The hydrokinetic torque-coupling device 110 of the second exemplary embodiment comprises a sealed casing 112 filled with a fluid, such as oil or transmission fluid, and rotatable about a rotational axis X of rotation, and a hydrokinetic torque converter 114 disposed in the casing 112. The sealed casing 112 and the torque converter 114 are both rotatable about the rotational axis X. The drawings discussed herein show half-views, that is, a cross-section of the portion or fragment of the hydrokinetic torque-coupling device 110 above rotational axis X. As is known in the art, the torque-coupling device 110 is symmetrical about the rotational axis X. Hereinafter the axial and radial orientations are considered with respect to the rotational axis X of the torque-coupling device 110. The relative terms such as “axially,” “radially,” and “circumferentially” are with respect to orientations parallel to, perpendicular to, and circularly around the rotational axis X, respectively.

The sealed casing 112 according to the second exemplary embodiment as illustrated in FIG. 4 includes a first casing shell 16, and a second casing shell 118 disposed coaxially with and axially opposite to the first casing shell 16. Moreover, the first casing shell 16 has a first connector flange 17 integral with and extending radially outwardly from the first casing shell 16, while the second casing shell 118 has a second connector flange 119 integral with and extending radially outwardly from the second casing shell 118. The first and second casing shells 16, 118 are non-movably (i.e., fixedly) interconnected and sealed together about their outer peripheries, such as by threaded fasteners 20, e.g. screws or bolts, or other mechanical fasteners. Specifically, the threaded fasteners 20 non-movably secure the first connector flange 17 of the first casing shell 16 to the second connector flange 119 of the second casing shell 118.

The second casing shell 118 is non-movably (i.e., fixedly) connected to the driving shaft, more typically to a flywheel (not shown) that is non-rotatably fixed to the driving shaft, so that the casing 112 turns at the same speed at which the engine operates for transmitting torque. Specifically, the casing 112 is rotatably driven by the internal combustion engine and is non-rotatably coupled to the flywheel thereof, such as with studs 13. As shown in FIG. 4, the studs 13 are fixedly secured, such as by welding, to the first casing shell 16. Each of the first and second casing shells 16, 118 are integral or one-piece and may be made, for example, by press-forming one-piece metal sheets.

The torque converter 114 comprises the impeller assembly 122, a turbine assembly 24, and a stator assembly 26 interposed axially between the impeller assembly 122 and the turbine assembly 24. The impeller assembly 122, the turbine assembly 24, and the stator assembly 26 are coaxially aligned with one another and the rotational axis X. The impeller assembly 122, the turbine assembly 24, and the stator assembly 26 are all rotatable about the rotational axis X. The impeller assembly 122, the turbine assembly 24, and the stator assembly 26 collectively form a torus. The impeller assembly 122 and the turbine assembly 24 may be fluidly coupled to one another in operation as known in the art.

The impeller assembly 122 includes a substantially annular impeller wheel 130 and an impeller hub 132 non-movably coupled to the impeller wheel 130. The impeller hub 132 is arranged for engagement with a hydraulic pump of the transmission. The impeller assembly 122, including the impeller wheel 130 and the impeller hub 132, is non-rotatably secured to the first casing shell 16 and hence to the drive shaft (or flywheel) of the engine to rotate at the same speed as the engine output. As best shown in FIGS. 4 and 5, the impeller wheel 130 is formed separately from the second casing shell 118, and non-movably connected to the second casing shell 118 by the threaded fasteners 20. On the other hand, the impeller hub 132 is formed unitarily with the second casing shell 118, such as a single-piece component. Thus, a portion of the second casing shell 118 of the casing 112 also forms and serves as the impeller hub 132 of the impeller assembly 122. Moreover, the impeller hub 132 has an annular, generally axially extending guiding flange 133_{S} and an annular, generally radially extending mounting flange 133_{M}. The guiding flange 133_{S} of the impeller hub 132 is configured to axially guide and radially center the impeller wheel 130 with respect to the impeller hub 132.

The impeller wheel 130, as best shown in FIG. 5, comprises a substantially annular, semi-toroidal (or concave) impeller shell member 136, a substantially annular impeller core ring member 38, and a plurality of impeller blade members 40 axially extending between the impeller shell member 136 and the impeller core ring member 38. Alternatively, the impeller wheel 130 does not include the impeller core ring member 38, only the impeller blade members 40 extend axially inwardly from the turbine shell member 136.

The impeller shell member 136 has a connector flange 137R integral with and extending radially outwardly from the impeller shell member 136, and a support flange 137A integral with and extending axially outwardly from the impeller shell member 136. The support flange 137A of the impeller shell member 136 is configured to radially support and center the first and second casing shells 16, 118 with respect to the impeller shell member 136. The first and second casing shells 16, 118 and the impeller shell member 136 are non-movably (i.e., fixedly) interconnected and sealed together about their outer peripheries, such as by threaded fasteners 20, e.g. screws or bolts, or other mechanical fasteners. Specifically, the threaded fasteners 20 non-movably secure the first connector flange 17 of the first casing shell 16, the connector flange 137R of the impeller shell member 136 and the second connector flange 119 of the second casing shell 118 to each other.

The impeller wheel 130 has a radially outer end 131o and a radially inner end 131i. As best shown in FIG. 4, the radially outer end 131o of the impeller wheel 130 is non-movably attached to both the first and second casing shells 16, 118 by the threaded fasteners 20, e.g. screws or bolts, or other mechanical fasteners, while the radially inner end 131i of the impeller wheel 130 is non-movably attached to the impeller hub 132 by the threaded fasteners 34, e.g. screws or bolts, or other mechanical fasteners.

The impeller wheel 130 and the turbine wheel 48 collectively define a substantially toroidal torus chamber 123 therebetween, as best shown in FIG. 4. Further referring to FIG. 4, a first chamber 125₁ is to the left side of the torque converter 114, and a second chamber 125₂ is to the other (right) side of the torque converter 114. In other words, the torus chamber 123 is defined within the torque converter 114, while the first chamber 125₁ is defined axially between the second casing shell 118 and the impeller wheel 130 (i.e., outside the torque converter 114), and the second chamber 125₂ is defined axially between the first casing shell 16 and the impeller wheel 130 (i.e., also outside the torque converter 114). Moreover, the impeller wheel 130 has a first communication opening 143₁ fluidly connecting the torus chamber 123 with the first chamber 125₁, and a second communication opening 143₂ fluidly connecting the first chamber 125₁ with the second chamber 125₂. According to the second exemplary embodiment of the present invention, the first communication opening 143₁ is located adjacent to the radially inner end 131i of the impeller wheel 130, while the second communication opening 143₂ is located adjacent to the radially outer end 131o of the impeller wheel 130, as best shown in FIGS. 4 and 5.

The impeller core ring member 38 and the impeller blade members 40 are formed unitary with the impeller shell member 136. Specifically, according to the second exemplary embodiment as best shown in FIG. 5, the impeller wheel 130 is manufactured as a single-piece component by an additive manufacturing (AM) process, such as 3D printing. Examples of additive manufacturing processes also include selective laser sintering (SLS) (technique that uses a laser as the power source to sinter powdered material (typically nylon/polyamide)), selective laser melting (SLM) (technique that uses a high power-density laser as the power source to melt and fuse material), fused deposition modeling (FDM) (works on an “additive” principle by laying down material in layers), and stereolithography (SLA; also known as stereolithography apparatus, optical fabrication, photo-solidification, or resin printing) which is a form of 3-D printing technology used for creating models, prototypes, patterns, and production parts in a layer by layer fashion using photo-polymerization, a process by which light causes chains of molecules to link, forming polymers, etc.

According to the second exemplary embodiment of the present invention, the second casing shell 118 with the impeller hub 132 is made of a metallic material (or metal), such as steel, while the impeller wheel 130 is made of a polymeric material (or polymer) including technical plastics, such as polyether ether ketone (PEEK) thermoplastic polymer (an organic thermoplastic polymer in the polyaryletherketone (PAEK) family), nylon and carbon fibers (e.g., Carbon Fiber CFF™), and resins, such as PLASTCure Rigid, etc.

Accordingly, an additive manufacturing process of making the impeller wheel 130 allows the manufacturer to optimize the profile and thickness of the turbine shell member 136, the turbine core ring member 38 and/or the turbine blade members 40 for better hydraulic and other performance. In other words, an impeller wheel 130 made by an additive manufacturing process from polymeric material can have variations in thickness, and be formed in very particular forms and shapes. Also, the molded turbine assembly can have reinforcing ribs. Thus, with the impeller wheel 130 of the present invention there is a possibility for mass optimization by putting the thickness where it is needed for strength and reducing the thickness where it is not needed and thus weight reduced, where stress and deformation are low.

Moreover, the impeller shell member 136, as best shown in FIG. 5, includes a substantially annular, semi-toroidal (or concave) impeller shell portion 142 and an impeller flange portion 144, radially inwardly extending from the impeller shell portion 142. The impeller shell member 136 of the impeller wheel 130 is non-movably (i.e., fixedly) secured to the mounting flange 133_{M} of the impeller hub 132 by the threaded fasteners 34 or other mechanical fasteners extending through openings in the impeller flange portion 144 and the steel ring 35 (as best shown in FIG. 5). In other words, the impeller wheel 130, made of a polymeric material, is non-movably (i.e., fixedly) secured to the impeller hub 132, made of a metallic material.

A method for assembling the hydrokinetic torque-coupling device 110 is as follows. First, the turbine assembly 24 and the stator 26 of the torque converter 114 may each be preassembled, as shown in FIG. 4. The impeller wheel 130 is made of polymeric material, such as plastic, resin, etc, by an additive manufacturing process. The polymeric materials used in making the impeller wheel 130 include technical plastics, such as PEEK, nylon and carbon fibers, and resins, such as PLASTCure Rigid, etc. Moreover, the impeller wheel 130 is manufactured as a single-piece component by the additive manufacturing process, such as SLS, SLM, FDM, SLA, etc.

Then, the second casing shell 118 formed unitarily with the impeller hub 132, such as a single-piece component made of metallic material, such as steel, is provided. Next, the impeller shell member 136 of the impeller wheel 130 is non-movably (i.e., fixedly) secured to the impeller hub 132 by appropriate means, such as by the screws 34 or other mechanical fasteners, or by welding, so as to form the impeller assembly 122, as best shown in FIG. 5.

Then, the impeller assembly 122, the turbine assembly 24 and the stator 26 are assembled together so as to form the torque converter 114, as best shown in FIG. 4. After that, the first casing shell 16 is sealingly fixed to the impeller wheel 130 and the second casing shell 118 of the casing 112, such as by welding or threaded fasteners 20 or other mechanical fasteners, so that the torque converter 114 is sealed within the casing 112, as best shown in FIG. 4.

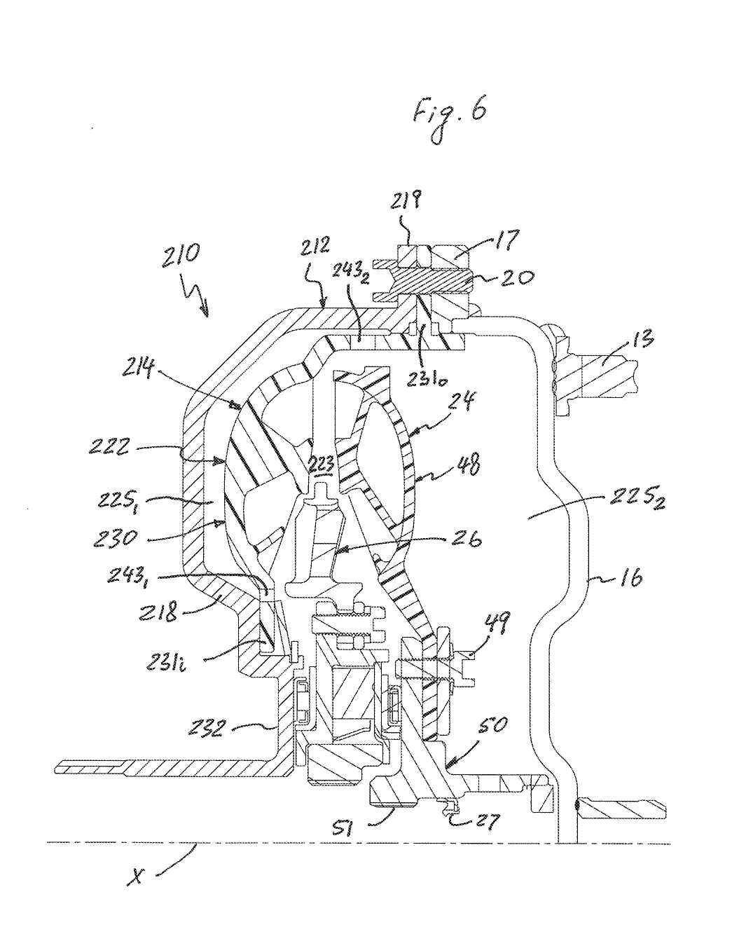

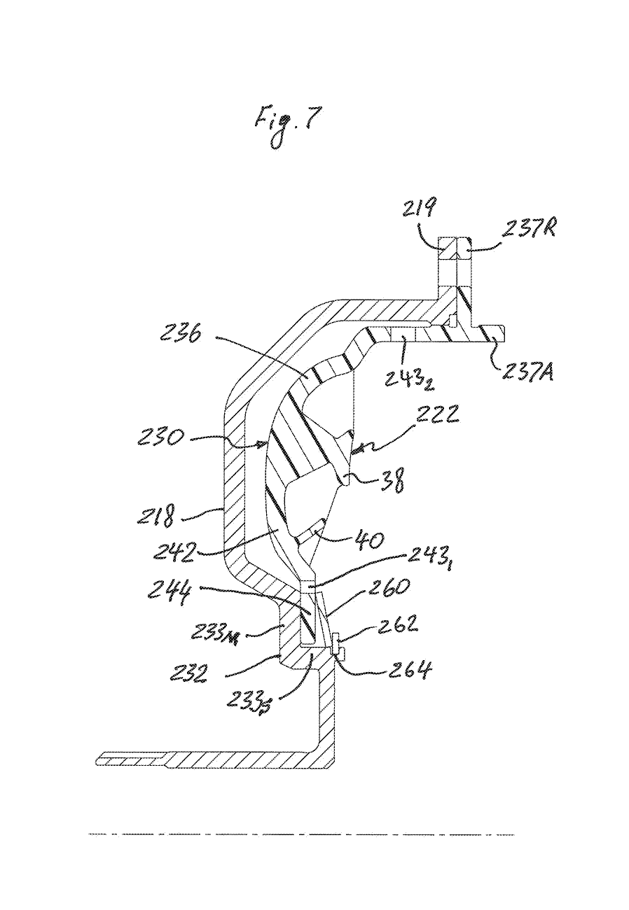

In a hydrokinetic torque-coupling device 210 of a third exemplary embodiment illustrated in FIGS. 6 and 7, the impeller assembly 122 of the second exemplary embodiment is replaced by an impeller assembly 222. The hydrokinetic torque-coupling device 210 of FIGS. 6 and 7 corresponds substantially to the hydrokinetic torque-coupling device 110 of FIGS. 4 and 5, and portions, which differ, will therefore be explained in detail below.

The hydrokinetic torque-coupling device 210 of the third exemplary embodiment comprises a sealed casing 212 filled with a fluid, such as oil or transmission fluid, and rotatable about a rotational axis X of rotation, and a hydrokinetic torque converter 214 disposed in the casing 212. The sealed casing 212 and the torque converter 214 are both rotatable about the rotational axis X. The drawings discussed herein show half-views, that is, a cross-section of the portion or fragment of the hydrokinetic torque-coupling device 210 above rotational axis X. As is known in the art, the torque-coupling device 210 is symmetrical about the rotational axis X. Hereinafter the axial and radial orientations are considered with respect to the rotational axis X of the torque-coupling device 210. The relative terms such as “axially,” “radially,” and “circumferentially” are with respect to orientations parallel to, perpendicular to, and circularly around the rotational axis X, respectively.

The sealed casing 212 according to the third exemplary embodiment as illustrated in FIG. 6 includes a first casing shell 16, and a second casing shell 218 disposed coaxially with and axially opposite to the first casing shell 16. Moreover, the first casing shell 16 has a first connector flange 17 integral with and extending radially outwardly from the first casing shell 16, while the second casing shell 218 has a second connector flange 219 integral with and extending radially outwardly from the second casing shell 218. The first and second casing shells 16, 218 are non-movably (i.e., fixedly) interconnected and sealed together about their outer peripheries, such as by threaded fasteners 20, e.g. screws or bolts, or other mechanical fasteners. Specifically, the threaded fasteners 20 non-movably secure the first connector flange 17 of the first casing shell 16 to the second connector flange 219 of the second casing shell 218.

The second casing shell 218 is non-movably (i.e., fixedly) connected to the driving shaft, more typically to a flywheel (not shown) that is non-rotatably fixed to the driving shaft, so that the casing 212 turns at the same speed at which the engine operates for transmitting torque. Specifically, the casing 212 is rotatably driven by the internal combustion engine and is non-rotatably coupled to the flywheel thereof, such as with studs 13. As shown in FIG. 6, the studs 13 are fixedly secured, such as by welding, to the first casing shell 16. Each of the first and second casing shells 16, 218 are integral or one-piece and may be made, for example, by press-forming one-piece metal sheets.

The torque converter 214 comprises an impeller assembly 222, a turbine assembly 24, and a stator assembly 26 interposed axially between the impeller assembly 222 and the turbine assembly 24. The impeller assembly 222, the turbine assembly 24, and the stator assembly 26 are coaxially aligned with one another and the rotational axis X. The impeller assembly 222, the turbine assembly 24, and the stator assembly 26 are all rotatable about the rotational axis X. The impeller assembly 222, the turbine assembly 24, and the stator assembly 26 collectively form a torus. The impeller assembly 222 and the turbine assembly 24 may be fluidly coupled to one another in operation as known in the art.

The impeller assembly 222 includes a substantially annular impeller wheel 230 and an impeller hub 232 non-movably coupled to the impeller wheel 230. The impeller hub 232 is arranged for engagement with a hydraulic pump of the transmission. The impeller assembly 222, including the impeller wheel 230 and the impeller hub 232, is non-rotatably secured to the first casing shell 16 and hence to the drive shaft (or flywheel) of the engine to rotate at the same speed as the engine output. As best shown in FIGS. 6 and 7, the impeller wheel 230 is formed separately from the second casing shell 218, and non-movably connected to the second casing shell 218 by the threaded fasteners 20. On the other hand, the impeller hub 232 is formed unitarily with the second casing shell 218, such as a single-piece component. Thus, a portion of the second casing shell 218 of the casing 212 also forms and serves as the impeller hub 232 of the impeller assembly 222. Moreover, the impeller hub 232 has an annular, generally axially extending guiding flange 233_{S} and an annular, generally radially extending mounting flange 233_{M}. The guiding flange 233_{S} of the impeller hub 232 is configured to axially guide and radially center the impeller wheel 230 with respect to the impeller hub 232, as best shown in FIG. 7.

The impeller wheel 230, as best shown in FIG. 7, comprises a substantially annular, semi-toroidal (or concave) impeller shell member 236, a substantially annular impeller core ring member 38, and a plurality of impeller blade members 40 axially extending between the impeller shell member 236 and the impeller core ring member 38. Alternatively, the impeller wheel 230 does not include the impeller core ring member 38, only the impeller blade members 40 extend axially inwardly from the turbine shell member 236.

The impeller shell member 236 has a connector flange 237R integral with and extending radially outwardly from the impeller shell member 236, and a support flange 237A integral with and extending axially outwardly from the impeller shell member 236. The support flange 237A of the impeller shell member 236 is configured to radially support and center the first and second casing shells 16, 218 with respect to the impeller shell member 236. The first and second casing shells 16, 218 and the impeller shell member 236 are non-movably (i.e., fixedly) interconnected and sealed together about their outer peripheries, such as by threaded fasteners 20, e.g. screws or bolts, or other mechanical fasteners. Specifically, the threaded fasteners 20 non-movably secure the first connector flange 17 of the first casing shell 16, the connector flange 237R of the impeller shell member 236 and the second connector flange 219 of the second casing shell 218 to each other.

The impeller core ring member 38 and the impeller blade members 40 are formed unitary with the impeller shell member 236. Specifically, according to the third exemplary embodiment as best shown in FIG. 7, the impeller wheel 230 is manufactured as a single-piece component by an additive manufacturing (AM) process, such as 3D printing. Examples of additive manufacturing process also include selective laser sintering (SLS) (technique that uses a laser as the power source to sinter powdered material (typically nylon/polyamide)), selective laser melting (SLM) (technique that uses a high power-density laser as the power source to melt and fuse material), fused deposition modeling (FDM) (works on an “additive” principle by laying down material in layers), and stereolithography (SLA; also known as stereolithography apparatus, optical fabrication, photo-solidification, or resin printing) which is a form of 3-D printing technology used for creating models, prototypes, patterns, and production parts in a layer by layer fashion using photo-polymerization, a process by which light causes chains of molecules to link, forming polymers, etc.

According to the third exemplary embodiment of the present invention, the second casing shell 218 with the impeller hub 232 is made of a metallic material (or metal), such as steel, while the impeller wheel 230 is made of a polymeric material (or polymer) including technical plastics, such as polyether ether ketone (PEEK) thermoplastic polymer (an organic thermoplastic polymer in the polyaryletherketone (PAEK) family), nylon and carbon fibers (e.g., Carbon Fiber CFF™), and resins, such as PLASTCure Rigid, etc.

Accordingly, an additive manufacturing process of making the impeller wheel 230 allows the manufacturer to optimize the profiles and thickness of the turbine shell member 236, the turbine core ring member 38 and/or the turbine blade members 40 for better hydraulic and other performance. In other words, an impeller wheel 230 made by an additive manufacturing process from polymeric material can have variations in thickness, and be formed in very particular forms and shapes. Also, the molded turbine assembly can have reinforcing ribs. Thus, with the impeller wheel 230 of the present invention there is a possibility for mass optimization by putting the thickness where it is needed for strength and reducing the thickness where it is not needed and thus weight reduced, where stress and deformation are low. Moreover, the impeller shell member 236, as best shown in FIG. 7, includes a substantially annular, semi-toroidal (or concave) impeller shell portion 242 and an impeller flange portion 244, radially inwardly extending from the impeller shell portion 242.

The impeller shell member 236 of the impeller wheel 230 is non-movably (i.e., fixedly) secured to the impeller hub 232 by the threaded fasteners 20 or other mechanical fasteners extending through openings in the connector flange 237R of the impeller shell member 236 and the second connector flange 219 of the second casing shell 218 (as best shown in FIG. 6). In other words, the impeller wheel 230, made of a polymeric material, is non-movably (i.e., fixedly) secured to the impeller hub 232, made of a metallic material.

Moreover, the impeller assembly 222 further comprises a resilient spring member 260 for applying a predetermined spring load to the impeller flange portion 244 of the impeller shell member 236 in the axial direction, to bias the impeller flange portion 244 of the impeller shell member 236 against the mounting flange 233_{M} of the impeller hub 232.

According to the third exemplary embodiment of the present invention, the spring member 260 is a Bellville spring (or spring washer). As best shown in FIG. 7, a radially outer end of the Bellville spring 260 applies a predetermined spring load to the impeller flange portion 244 of the impeller shell member 236 in the axial direction. A radially inner end of the Bellville spring 260 abuts a retention member, such as a C-ring (or split ring) 262 mounted in a complementary annular groove 264 formed in in a radially outer peripheral surface of the guiding flange 233_{S} of the impeller hub 232. The C-ring 262 prevents axial displacement of the Bellville spring 260 in the axial direction away from the impeller hub 232.

The impeller wheel 230 has a radially outer end 231o and a radially inner end 231i. As best shown in FIG. 6, the radially outer end 231o of the impeller wheel 230 is non-movably attached to both the first and second casing shells 16, 218 by the threaded fasteners 20, e.g. screws or bolts, or other mechanical fasteners, while the radially inner end 231i of the impeller wheel 230 is axially biased against the mounting flange 233_{M} of the impeller hub 232 by the spring washer 260.

The impeller wheel 230 and the turbine wheel 48 collectively define a substantially toroidal torus chamber 223 therebetween, as best shown in FIG. 6. Further referring to FIG. 6, a first chamber 225₁ is to the left side of the torque converter 214, and a second chamber 225₂ is to the other (right) side of the torque converter 214. In other words, the torus chamber 223 is defined within the torque converter 214, while the first chamber 225₁ is defined axially between the second casing shell 218 and the impeller wheel 230 (i.e., outside the torque converter 214), and the second chamber 225₂ is defined axially between the first casing shell 16 and the impeller wheel 230 (i.e., also outside the torque converter 214). Moreover, the impeller wheel 230 has a first communication opening 243₁ fluidly connecting the torus chamber 223 with the first chamber 225₁, and a second communication opening 243₂ fluidly connecting the first chamber 225₁ with the second chamber 225₂. According to the third exemplary embodiment of the present invention, the first communication opening 243₁ is located adjacent to the radially inner end 231i of the impeller wheel 230, while the second communication opening 243₂ is located adjacent to the radially outer end 231o of the impeller wheel 230, as best shown in FIGS. 6 and 7.

A method for assembling the hydrokinetic torque-coupling device 210 is as follows. First, the turbine assembly 24 and the stator 26 of the torque converter 214 may each be preassembled, as shown in FIG. 6. The impeller wheel 230 is made of a polymeric material, such as plastic, resin, etc, by an additive manufacturing process. The polymeric materials used in making the impeller wheel 230 include technical plastics, such as PEEK, nylon and carbon fibers, and resins, such as PLASTCure Rigid, etc. Moreover, the impeller wheel 230 is manufactured as a single-piece component by an additive manufacturing process, such as SLS, SLM, FDM, SLA, etc.

Then, the second casing shell 218 formed unitarily with the impeller hub 232, such as a single-piece component made of a metallic material, such as steel, is provided. Next, the impeller shell member 236 of the impeller wheel 230 is placed axially around the guiding flange 233_{S} of the impeller hub 232. Then, the Bellville spring 260 is placed axially around the guiding flange 233_{S} of the impeller hub 232 next to the impeller flange portion 244 of the impeller wheel 230, so that the impeller flange portion 244 is disposed between the mounting flange 233_{M} of the impeller hub 232 and the Bellville spring 260. Next, the Bellville spring 260 is compressed axially in the direction toward the mounting flange 233_{M} of the impeller hub 232. After that, while the Bellville spring 260 is compressed, the C-ring 262 is placed into the groove 264 in the guiding flange 233_{S} of the impeller hub 232 next to the Bellville spring 260 so as to retain the Bellville spring 260 on the mounting flange 233_{M} of the impeller hub 232, preferably in a compressed position, biasing the impeller flange portion 244 of the impeller shell member 236 against the mounting flange 233_{M} of the impeller hub 232.

Then, the impeller assembly 222, the turbine assembly 24 and the stator 26 are assembled together to form the torque converter 214, as best shown in FIG. 6. After that, the first casing shell 16, the impeller wheel 230 and the second casing shell 218 of the casing 212 are fixed to each other, such as by the threaded fasteners 20 or other mechanical fasteners, so that the torque converter 214 is sealed within the casing 212, as best shown in FIG. 6.

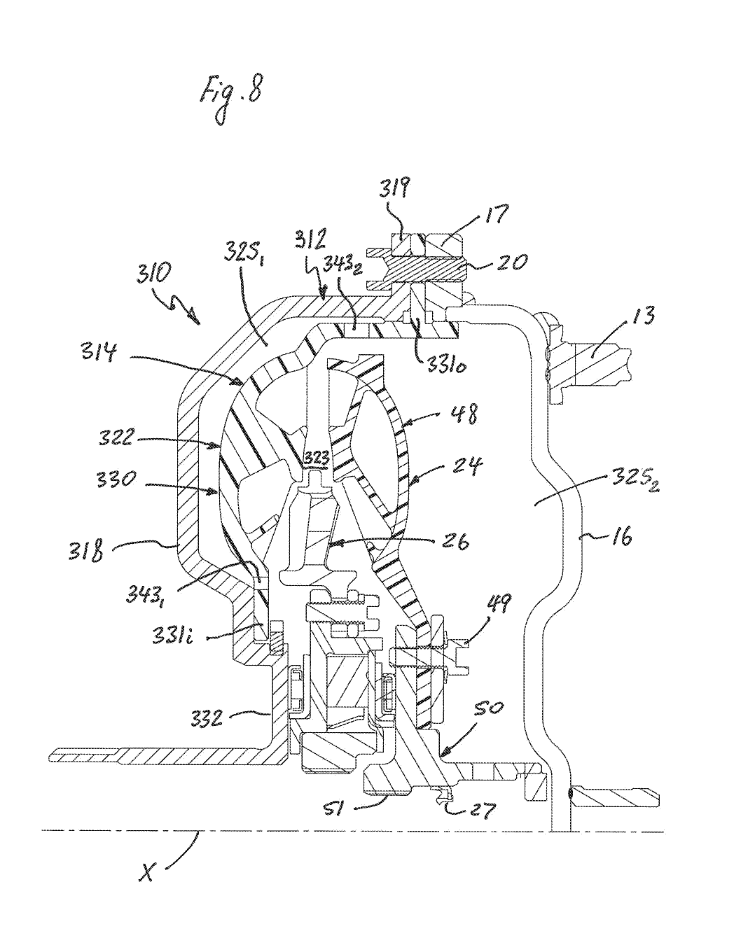

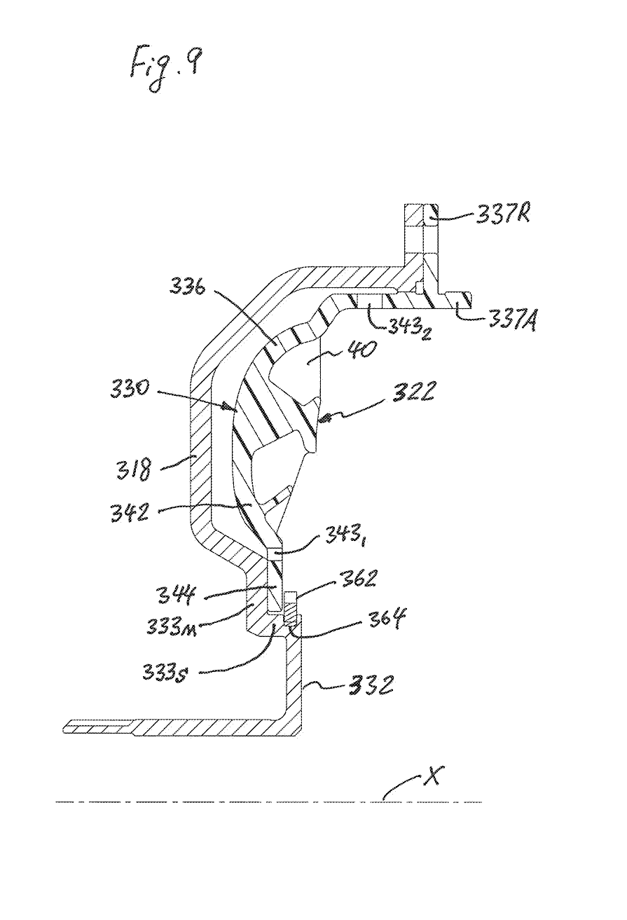

In a hydrokinetic torque-coupling device 310 of a fourth exemplary embodiment illustrated in FIGS. 8 and 9, the impeller assembly 222 of the third exemplary embodiment is replaced by an impeller assembly 322. The hydrokinetic torque-coupling device 310 of FIGS. 8 and 9 corresponds substantially to the hydrokinetic torque-coupling device 210 of FIGS. 6 and 7, and portions, which differ, will therefore be explained in detail below.

The hydrokinetic torque-coupling device 310 of the fourth exemplary embodiment comprises a sealed casing 312 filled with a fluid, such as oil or transmission fluid, and rotatable about a rotational axis X of rotation, and a hydrokinetic torque converter 314 disposed in the casing 312. The sealed casing 312 and the torque converter 314 are both rotatable about the rotational axis X. The drawings discussed herein show half-views, that is, a cross-section of the portion or fragment of the hydrokinetic torque-coupling device 310 above rotational axis X. As is known in the art, the torque-coupling device 310 is symmetrical about the rotational axis X. Hereinafter the axial and radial orientations are considered with respect to the rotational axis X of the torque-coupling device 310. The relative terms such as “axially,” “radially,” and “circumferentially” are with respect to orientations parallel to, perpendicular to, and circularly around the rotational axis X, respectively.

The sealed casing 312 according to the third exemplary embodiment as illustrated in FIG. 8 includes a first casing shell 16, and a second casing shell 318 disposed coaxially with and axially opposite to the first casing shell 16. Moreover, the first casing shell 16 has a first connector flange 17 integral with (i.e., non-movably attached to) and extending radially outwardly from the first casing shell 16, while the second casing shell 318 has a second connector flange 319 integral with and extending radially outwardly from the second casing shell 318. The first and second casing shells 16, 318 are non-movably (i.e., fixedly) interconnected and sealed together about their outer peripheries, such as by threaded fasteners 20, e.g. screws or bolts, or other mechanical fasteners. Specifically, the threaded fasteners 20 non-movably secure the first connector flange 17 of the first casing shell 16 to the second connector flange 319 of the second casing shell 318.

The second casing shell 318 is non-movably (i.e., fixedly) connected to the driving shaft, more typically to a flywheel (not shown) that is non-rotatably fixed to the driving shaft, so that the casing 312 turns at the same speed at which the engine operates for transmitting torque. Each of the first and second casing shells 16, 318 are integral or one-piece and may be made, for example, by press-forming one-piece metal sheets.

The torque converter 314 comprises an impeller assembly 322, a turbine assembly 24, and a stator assembly 26 interposed axially between the impeller assembly 322 and the turbine assembly 24. The impeller assembly 322, the turbine assembly 24, and the stator assembly 26 are coaxially aligned with one another and the rotational axis X. The impeller assembly 322, the turbine assembly 24, and the stator assembly 26 are all rotatable about the rotational axis X. The impeller assembly 322, the turbine assembly 24, and the stator assembly 26 collectively form a torus. The impeller assembly 322 and the turbine assembly 24 may be fluidly coupled to one another in operation as known in the art.

The impeller assembly 322 includes a substantially annular impeller wheel 330 and an impeller hub 332 non-movably coupled to the impeller wheel 330. The impeller hub 332 is arranged for engagement with a hydraulic pump of the transmission. The impeller assembly 322, including the impeller wheel 330 and the impeller hub 332, is non-rotatably secured to the first casing shell 16 and hence to the drive shaft (or flywheel) of the engine to rotate at the same speed as the engine output. As best shown in FIGS. 8 and 9, the impeller wheel 330 is formed separately from the second casing shell 318, and non-movably connected to the second casing shell 318 by the threaded fasteners 20. On the other hand, the impeller hub 332 is formed unitarily with the second casing shell 318, such as a single-piece component. Thus, a portion of the second casing shell 318 of the casing 312 also forms and serves as the impeller hub 332 of the impeller assembly 322. Moreover, the impeller hub 332 has an annular, generally axially extending guiding flange 333_{S} and an annular, generally radially extending mounting flange 333_{M}. The guiding flange 333_{S} of the impeller hub 332 is configured to axially guide and radially center the impeller wheel 330 with respect to the impeller hub 332, as best shown in FIG. 9.

The impeller wheel 330, as best shown in FIG. 9, comprises a substantially annular, semi-toroidal (or concave) impeller shell member 336, a substantially annular impeller core ring member 38, and a plurality of impeller blade members 40 axially extending between the impeller shell member 336 and the impeller core ring member 38.

The impeller shell member 336 has a connector flange 337R integral with and extending radially outwardly from the impeller shell member 336, and a support flange 337A integral with and extending axially outwardly from the impeller shell member 336. The support flange 337A of the impeller shell member 336 is configured to radially support and center the first and second casing shells 16, 318 with respect to the impeller shell member 336. The first and second casing shells 16, 318 and the impeller shell member 336 are non-movably (i.e., fixedly) interconnected and sealed together about their outer peripheries, such as by threaded fasteners 20, e.g. screws or bolts, or other mechanical fasteners. Specifically, the threaded fasteners 20 non-movably secure the first connector flange 17 of the first casing shell 16, the connector flange 337R of the impeller shell member 336 and the second connector flange 319 of the second casing shell 318 to each other.

The impeller core ring member 38 and the impeller blade members 40 are formed unitary with the impeller shell member 336. Specifically, according to the second exemplary embodiment as best shown in FIG. 9, the impeller wheel 330 is manufactured as a single-piece component by an additive manufacturing (AM) process.

According to the fourth exemplary embodiment of the present invention, the second casing shell 318 with the impeller hub 332 is made of a metallic material (or metal), such as steel, while the impeller wheel 330 is made of a polymeric material (or polymer) including technical plastics, such as polyether ether ketone (PEEK) thermoplastic polymer (an organic thermoplastic polymer in the polyaryletherketone (PAEK) family), nylon and carbon fibers (e.g., Carbon Fiber CFF™), and resins, such as PLASTCure Rigid, etc.

The impeller shell member 336, as best shown in FIG. 9, includes a substantially annular, semi-toroidal (or concave) impeller shell portion 342 and an impeller flange portion 344, radially inwardly extending from the impeller shell portion 342.

The impeller shell member 336 of the impeller wheel 330 is fixedly secured to the impeller hub 332 by the threaded fasteners 20 or other mechanical fasteners extending through openings in the connector flange 337R of the impeller shell member 336 and the second connector flange 319 of the second casing shell 318 (as best shown in FIG. 8). In other words, the impeller wheel 330, made of a polymeric material, is non-movably (i.e., fixedly) secured to the impeller hub 332, made of a metallic material.

Moreover, according to the fourth exemplary embodiment of the present invention, the impeller flange portion 344 of the impeller shell member 336 is disposed around the guiding flange 333_{S} of the impeller hub 332 adjacent to or juxtaposed with the mounting flange 233_{M} of the impeller hub 232. The impeller flange portion 344 of the impeller shell member 336 is retained on the guiding flange 333_{S} of the impeller hub 332 by a retention member, such as a C-ring (or split ring) 362 mounted in a suitable (or complementary) annular groove 364 formed in in a radially outer peripheral surface of the guiding flange 333_{S} of the impeller hub 332. As best shown in FIG. 9, the impeller flange portion 344 of the impeller shell member 336 is disposed axially between the mounting flange 333_{M} of the impeller hub 332 and the retention member 362 so as to prevent axial displacement of the impeller flange portion 344 of the impeller shell member 336 in the axial direction away from the mounting flange 333_{M} of the impeller hub 332.

The impeller wheel 330 has a radially outer end 331o and a radially inner end 331i. As best shown in FIG. 8, the radially outer end 331o of the impeller wheel 330 is non-movably attached to both the first and second casing shells 16, 318 by the threaded fasteners 20, e.g. screws or bolts, or other mechanical fasteners, while the radially inner end 331i of the impeller wheel 330 is prevented from displacement in the axial direction away from the mounting flange 333_{M} of the impeller hub 332 by the retention member 362.

The impeller wheel 330 and the turbine wheel 48 collectively define a substantially toroidal torus chamber 323 therebetween, as best shown in FIG. 8. Further referring to FIG. 8, a first chamber 325₁ is to the left side of the torque converter 314, and a second chamber 325₂ is to the other (right) side of the torque converter 314. In other words, the first torus chamber 323 is defined within the torque converter 314, while the first chamber 325₁ is defined axially between the second casing shell 318 and the impeller wheel 330 (i.e., outside the torque converter 314), and the second chamber 325₂ is defined axially between the first casing shell 16 and the impeller wheel 330 (i.e., also outside the torque converter 314). Moreover, the impeller wheel 330 has a first communication opening 343₁ fluidly connecting the torus chamber 323 with the first chamber 325₁, and a second communication opening 343₂ fluidly connecting the first chamber 325₁ with the second chamber 325₂. According to the fourth exemplary embodiment of the present invention, the first communication opening 343₁ is located adjacent to the radially inner end 331i of the impeller wheel 330, while the second communication opening 343₂ is located adjacent to the radially outer end 331o of the impeller wheel 330, as best shown in FIGS. 8 and 9.

A method for assembling the hydrokinetic torque-coupling device 310 is as follows. First, the turbine assembly 24 and the stator 26 of the torque converter 314 may each be preassembled, as shown in FIG. 8. The impeller wheel 330 is made of a polymeric material, such as plastic, resin, etc, by an additive manufacturing process. The polymeric materials used in making the impeller wheel 230 include technical plastics, such as PEEK, nylon and carbon fibers, and resins, such as PLASTCure Rigid, etc. Moreover, the impeller wheel 330 is manufactured as a single-piece component by an additive manufacturing process, such as SLS, SLM, FDM, SLA, etc.

Then, the second casing shell 318 formed unitarily with the impeller hub 332, such as a single-piece component made of metallic material, such as steel, is provided. Next, the impeller shell member 336 of the impeller wheel 330 is placed axially around the guiding flange 333_{S} of the impeller hub 332 adjacent to or juxtaposed with the mounting flange 233_{M} of the impeller hub 232. Afterward, the C-ring 362 is mounted into the groove 364 in the guiding flange 333_{S} of the impeller hub 332 to retain the impeller flange portion 344 of the impeller shell member 336 on the mounting flange 333_{M} of the impeller hub 332.

Then, the impeller assembly 322, the turbine assembly 24 and the stator 26 are assembled together so as to form the torque converter 314, as best shown in FIG. 8. After that, the first casing shell 16, the impeller wheel 330 and the second casing shell 318 of the casing 312 are fixed to each other, such as by the threaded fasteners 20 or other mechanical fasteners, so that the torque converter 314 is sealed within the casing 312, as best shown in FIG. 8.

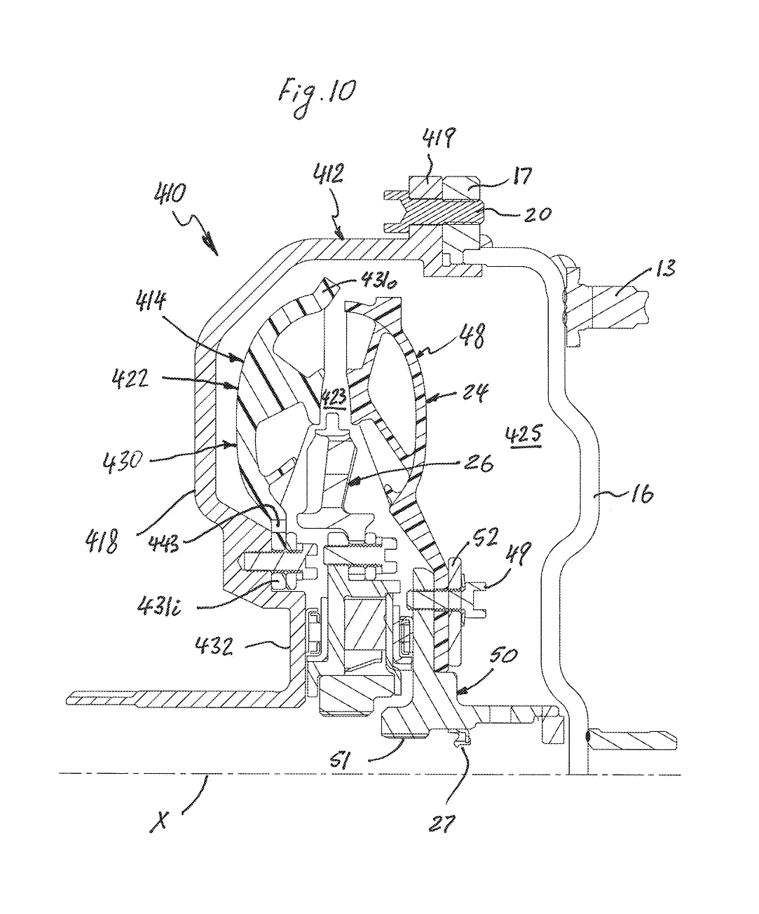

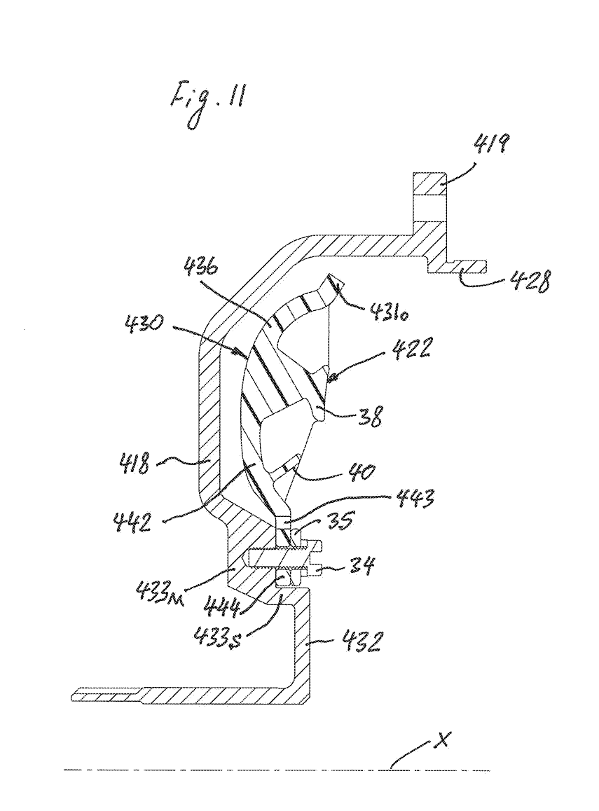

In a hydrokinetic torque-coupling device 410 of a fifth exemplary embodiment illustrated in FIGS. 10 and 11, the impeller assembly 122 of the second exemplary embodiment is replaced by an impeller assembly 422. The hydrokinetic torque-coupling device 410 of FIGS. 10 and 11 corresponds substantially to the hydrokinetic torque-coupling device 110 of FIGS. 4 and 5, and portions which differ will therefore be explained in detail below.

The hydrokinetic torque-coupling device 410 of the fifth exemplary embodiment comprises a sealed casing 412 filled with a fluid, such as oil or transmission fluid, and rotatable about a rotational axis X of rotation, and a hydrokinetic torque converter 414 disposed in the casing 412. The sealed casing 412 and the torque converter 414 are both rotatable about the rotational axis X.

The sealed casing 412 according to the fifth exemplary embodiment as illustrated in FIG. 10 includes a first casing shell 16, and a second casing shell 418 disposed coaxially with and axially opposite to the first casing shell 16. Moreover, the first casing shell 16 has a first connector flange 17 integral with and extending radially outwardly from the first casing shell 16, while the second casing shell 418 has a second connector flange 419 integral with and extending radially outwardly from the second casing shell 418. The first and second casing shells 16, 418 are non-movably (i.e., fixedly) interconnected and sealed together about their outer peripheries, such as by threaded fasteners 20, e.g. screws or bolts, or other mechanical fasteners. Specifically, the threaded fasteners 20 non-movably secure the first connector flange 17 of the first casing shell 16 to the second connector flange 419 of the second casing shell 418. The second casing shell 418 also has an integral support flange 428 extending axially outwardly toward the first casing shell 16. The support flange 428 of the second casing shell 418 is configured to radially support and center the first casing shell 16 with respect to the second casing shell 418.

The second casing shell 418 is non-movably connected (i.e., fixed) to the driving shaft, more typically to a flywheel (not shown) that is non-rotatably fixed to the driving shaft, so that the casing 412 turns at the same speed at which the engine operates for transmitting torque. Specifically, the casing 412 is rotatably driven by the internal combustion engine and is non-rotatably coupled to the flywheel thereof, such as with studs 13. As shown in FIG. 10, the studs 13 are fixedly secured, such as by welding, to the first casing shell 16. Each of the first and second casing shells 16, 418 are integral or one-piece and may be made, for example, by press-forming one-piece metal sheets.

The torque converter 414 comprises an impeller assembly 422, a turbine assembly 24, and a stator assembly 26 interposed axially between the impeller assembly 422 and the turbine assembly 24. The impeller assembly 422, the turbine assembly 24, and the stator assembly 26 are coaxially aligned with one another and the rotational axis X. The impeller assembly 422, the turbine assembly 24, and the stator assembly 26 are all rotatable about the rotational axis X. The impeller assembly 422, the turbine assembly 24, and the stator assembly 26 collectively form a torus. The impeller assembly 422 and the turbine assembly 24 may be fluidly coupled to one another in operation as known in the art.

The impeller assembly 422 includes a substantially annular impeller wheel 430 and an impeller hub 432 non-movably coupled to the impeller wheel 430. The impeller hub 432 is arranged for engagement with a hydraulic pump of the transmission. The impeller assembly 422, including the impeller wheel 430 and the impeller hub 432, is non-rotatably secured to the first casing shell 16 and hence to the drive shaft (or flywheel) of the engine to rotate at the same speed as the engine output. As best shown in FIGS. 10 and 11, the impeller wheel 430 is formed separately from the second casing shell 418, and non-movably connected to the second casing shell 418 by the threaded fasteners 20. On the other hand, the impeller hub 432 is formed unitarily with the second casing shell 418, such as a single-piece component. Thus, a portion of the second casing shell 418 of the casing 412 also forms and serves as the impeller hub 432 of the impeller assembly 422. Moreover, the impeller hub 432 has an annular, generally axially extending guiding flange 433_{S} and an annular, generally radially extending mounting flange 433_{M}. The guiding flange 433_{S} of the impeller hub 432 is configured to axially guide and radially center the impeller wheel 430 with respect to the impeller hub 432, as best shown in FIG. 11.

The impeller wheel 430, as best shown in FIG. 11, comprises a substantially annular, semi-toroidal (or concave) impeller shell member 436, a substantially annular impeller core ring member 38, and a plurality of impeller blade members 40 axially extending between the impeller shell member 436 and the impeller core ring member 38. Alternatively, the impeller wheel 430 does not include the impeller core ring member 38, only the impeller blade members 40 extend axially inwardly from the turbine shell member 436.

The impeller core ring member 38 and the impeller blade members 40 are formed unitary with the impeller shell member 436. Specifically, according to the exemplary embodiment as best shown in FIG. 11, the impeller wheel 430 is manufactured as a single-piece component by an additive manufacturing (AM) process

Further according to the exemplary embodiment of the present invention, the second casing shell 418 with the impeller hub 232 is made of a metallic material (or metal), such as steel, while the impeller wheel 430 is made of a polymeric material (or polymer) including technical plastics, such as polyether ether ketone (PEEK) thermoplastic polymer (an organic thermoplastic polymer in the polyaryletherketone (PAEK) family), nylon and carbon fibers (e.g., Carbon Fiber CFF™), and resins, such as PLASTCure Rigid, etc.

The impeller shell member 436, as best shown in FIG. 11, includes a substantially annular, semi-toroidal (or concave) impeller shell portion 442 and an impeller flange portion 444, radially inwardly extending from the impeller shell portion 442.

The impeller shell member 436, as best shown in FIG. 11, includes a substantially annular, semi-toroidal (or concave) impeller shell portion 442 and an impeller flange portion 444, radially inwardly extending from the impeller shell portion 442. The impeller shell member 436 of the impeller wheel 430 is non-movably (i.e., fixedly) secured to the mounting flange 433_{M} of the impeller hub 432 by the threaded fasteners 34 or other mechanical fasteners extending through openings in the impeller flange portion 444 and the washers 35 (as best shown in FIG. 11). In other words, the impeller wheel 430, made of polymeric material, is non-movably (i.e., fixedly) secured to the impeller hub 432, made of metallic material.

The impeller wheel 430 has a radially outer end 4310 and a radially inner end 431i. As best shown in FIG. 10, the radially outer end 4310 of the impeller wheel 230 is radially spaced from the second casing shell 418, while the radially inner end 431i of the impeller wheel 430 is non-movably attached to the impeller hub 432 by the threaded fasteners 34, e.g. screws or bolts, or other mechanical fasteners.

The impeller wheel 430 and the turbine wheel 48 collectively define a substantially toroidal torus chamber 423 therebetween, as best shown in FIG. 10. Further referring to FIG. 10, an outer chamber 425 is outside of the torque converter 414. In other words, the torus chamber 423 is defined within the torque converter 414, while the outer chamber 425 is defined outside the torque converter 414). Moreover, the impeller wheel 430 has a communication opening 443 fluidly connecting the torus chamber 423 with the outer chamber 425. According to the fifth exemplary embodiment of the present invention, the communication opening 443 is located adjacent to the radially inner end 431i of the impeller wheel 430, as best shown in FIGS. 10 and 11.

A method for assembling the hydrokinetic torque-coupling device 410 is as follows. First, the turbine assembly 24 and the stator 26 of the torque converter 414 may each be preassembled, as shown in FIG. 10. The impeller wheel 430 is made of a polymeric material, such as plastic, resin, etc, by an additive manufacturing process. The polymeric materials used in making the impeller wheel 430 include technical plastics, such as PEEK, nylon and carbon fibers, and resins, such as PLASTCure Rigid, etc. Moreover, the impeller wheel 430 is manufactured as a single-piece component by an additive manufacturing process, such as SLS, SLM, FDM, SLA, etc.

Then, the second casing shell 418 formed unitarily with the impeller hub 432, such as a single-piece component made of a metallic material, such as steel, is provided. Next, the impeller shell member 436 of the impeller wheel 430 is non-movably (i.e., fixedly) secured to the impeller hub 432 by appropriate means, such as by the screws 34 or other mechanical fasteners, or by welding, so as to form the impeller assembly 422, as best shown in FIG. 11.

Then, the impeller assembly 422, the turbine assembly 24 and the stator 26 are assembled together to form the torque converter 414, as best shown in FIG. 10. After that, the first casing shell 16 is sealingly fixed to the second casing shell 418 of the casing 412, such as by welding or threaded fasteners 20 or other mechanical fasteners, so that the torque converter 414 is sealed within the casing 412, as best shown in FIG. 10.

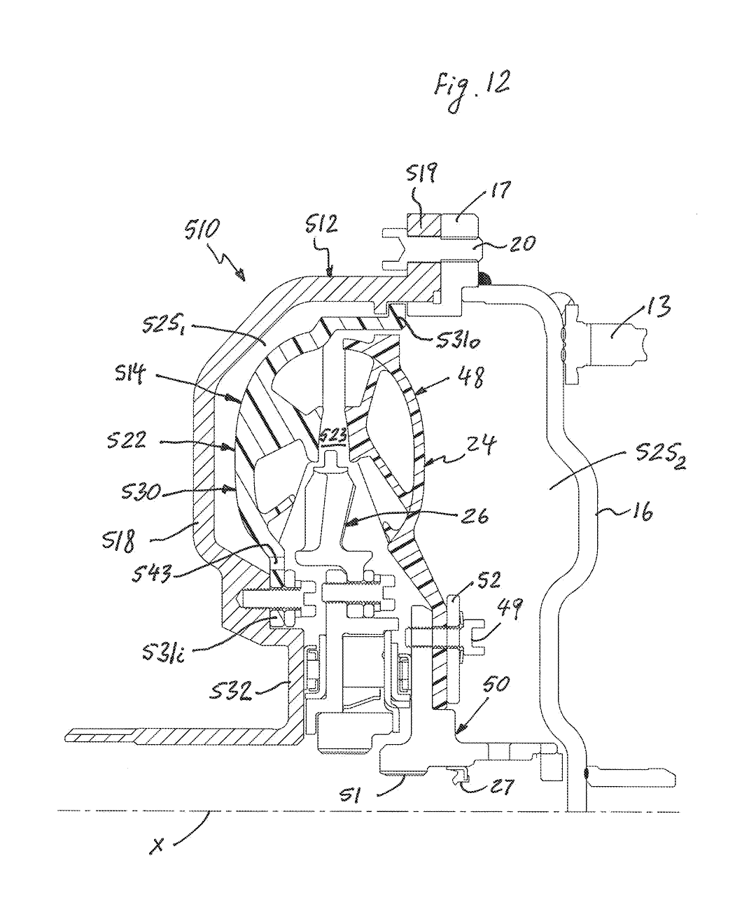

In a hydrokinetic torque-coupling device 510 of a sixth exemplary embodiment illustrated in FIGS. 12-14, the impeller assembly 122 of the second exemplary embodiment is replaced by an impeller assembly 522. The hydrokinetic torque-coupling device 510 of FIGS. 12-14 corresponds substantially to the hydrokinetic torque-coupling device 110 of FIGS. 4 and 5, and portions, which differ, will therefore be explained in detail below.

The hydrokinetic torque-coupling device 510 of the sixth exemplary embodiment comprises a sealed casing 512 filled with a fluid, such as oil or transmission fluid, and rotatable about a rotational axis X of rotation, and a hydrokinetic torque converter 514 disposed in the casing 512. The sealed casing 512 and the torque converter 514 are both rotatable about the rotational axis X. The drawings discussed herein show half-views, that is, a cross-section of the portion or fragment of the hydrokinetic torque-coupling device 510 above rotational axis X. As is known in the art, the torque-coupling device 510 is symmetrical about the rotational axis X. Hereinafter the axial and radial orientations are considered with respect to the rotational axis X of the torque-coupling device 510.

The sealed casing 512 according to the sixth exemplary embodiment as illustrated in FIG. 12 includes a first casing shell 16, and a second casing shell 518 disposed coaxially with and axially opposite to the first casing shell 16. Moreover, the first casing shell 16 has a first connector flange 17 integral with and extending radially outwardly from the first casing shell 16, while the second casing shell 518 has a second connector flange 519 integral with and extending radially outwardly from the second casing shell 518. The first and second casing shells 16, 518 are non-movably (i.e., fixedly) interconnected and sealed together about their outer peripheries, such as by threaded fasteners 20, e.g. screws or bolts, or other mechanical fasteners. Specifically, the threaded fasteners 20 non-movably secure the first connector flange 17 of the first casing shell 16 to the second connector flange 519 of the second casing shell 518.

The second casing shell 518 is non-movably (i.e., fixedly) connected to the driving shaft, more typically to a flywheel (not shown) that is non-rotatably fixed to the driving shaft, so that the casing 512 turns at the same speed at which the engine operates for transmitting torque. Specifically, the casing 512 is rotatably driven by the internal combustion engine and is non-rotatably coupled to the flywheel thereof, such as with studs 13. Each of the first and second casing shells 16, 518 are integral or one-piece and may be made, for example, by press-forming one-piece metal sheets.

The torque converter 514 comprises the impeller assembly 522, a turbine assembly 24, and a stator assembly 26 interposed axially between the impeller assembly 522 and the turbine assembly 24. The impeller assembly 522, the turbine assembly 24, and the stator assembly 26 are coaxially aligned with one another and the rotational axis X. The impeller assembly 522, the turbine assembly 24, and the stator assembly 26 are all rotatable about the rotational axis X. The impeller assembly 522, the turbine assembly 24, and the stator assembly 26 collectively form a torus. The impeller assembly 522 and the turbine assembly 24 may be fluidly coupled to one another in operation as known in the art.

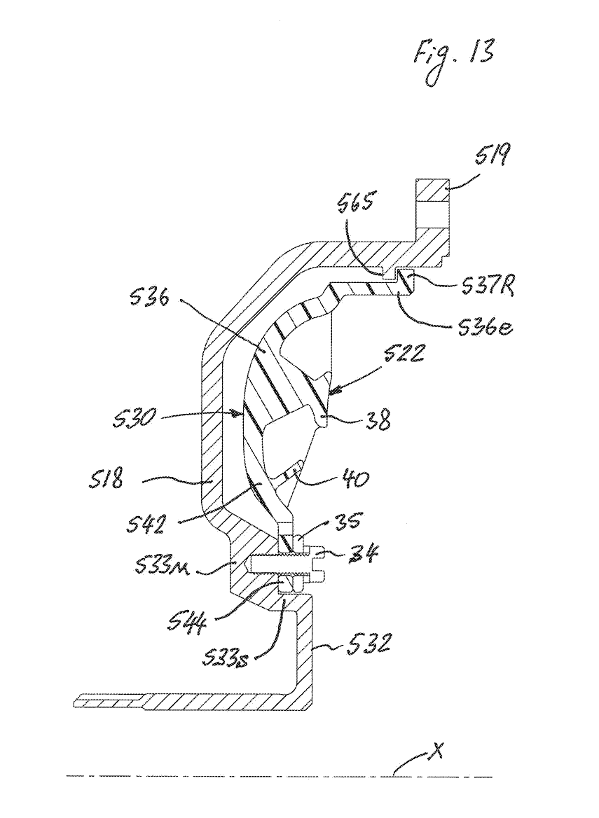

The impeller assembly 522 includes a substantially annular impeller wheel 530 and an impeller hub 532 non-movably coupled to the impeller wheel 530. The impeller hub 532 is arranged for engagement with a hydraulic pump of the transmission. The impeller assembly 522, including the impeller wheel 530 and the impeller hub 532, is non-rotatably secured to the first casing shell 16 and hence to the drive shaft (or flywheel) of the engine to rotate at the same speed as the engine output. As best shown in FIGS. 12 and 13, the impeller wheel 530 is formed separately from the second casing shell 518, and non-movably connected to the second casing shell 518 by threaded fasteners 34. On the other hand, the impeller hub 532 is formed unitarily with the second casing shell 518, such as a single-piece component. Thus, a portion of the second casing shell 518 of the casing 512 also forms and serves as the impeller hub 532 of the impeller assembly 522. Thus, the impeller wheel 530 is non-movably connected to the impeller hub 532 by the threaded fasteners 34. Moreover, the impeller hub 532 has an annular, generally axially extending guiding flange 533_{S} and an annular, generally radially extending mounting flange 533_{M}, as best shown in FIG. 13. The guiding flange 533_{S} of the impeller hub 532 is configured to radially support and center the impeller wheel 530 with respect to the impeller hub 532.

The impeller wheel 530, as best shown in FIG. 13, comprises a substantially annular, semi-toroidal (or concave) impeller shell member 536, a substantially annular impeller core ring member 38, and a plurality of impeller blade members 40 axially extending between the impeller shell member 536 and the impeller core ring member 38. Alternatively, the impeller wheel 530 does not include the impeller core ring member 38, only the impeller blade members 40 extend axially inwardly from the turbine shell member 536.

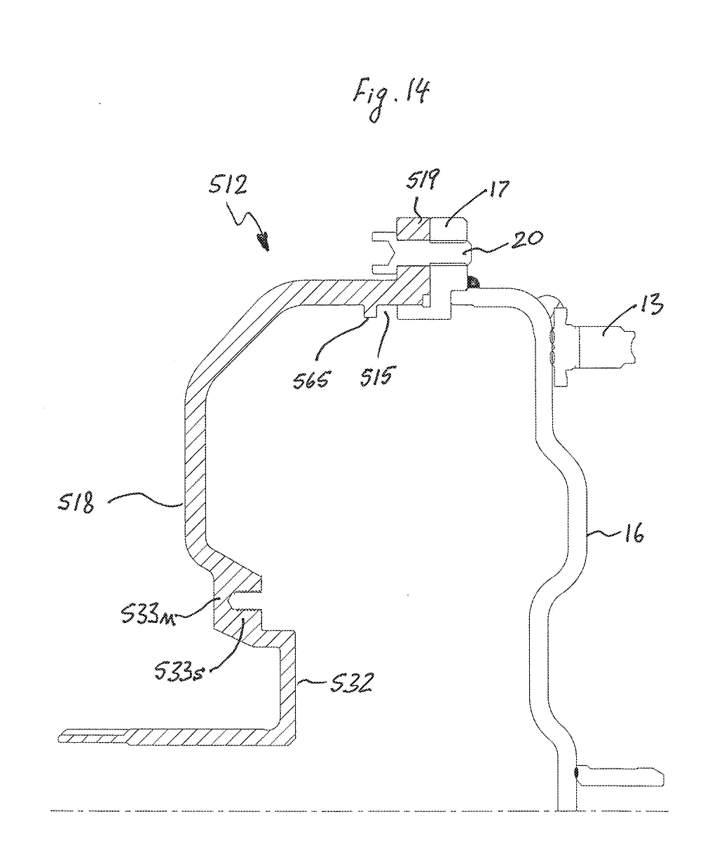

The impeller shell member 536 has a guide flange 537R integral with and extending radially outwardly from a radially outer end 536e the impeller shell member 536, as best shown in FIG. 13. The guide flange 537R of the impeller shell member 536 is disposed in a suitable (or complementary) annular guiding groove 515 formed in in a radially inner peripheral surface of the casing 512, as best shown in FIGS. 12 and 14. Specifically, the guiding groove 515 is defined between the first connector flange 17 of the first casing shell 16 and a guiding rib 565 extending radially inwardly from and unitary with the second casing shell 518 when the first and second casing shells 16, 518 are fixed to one another by the threaded fasteners 20, as best shown in FIG. 14. The guide flange 537R of the impeller shell member 536 is configured to rotatably guide, to radially center the impeller wheel 530 within the casing 512, and to prevent axial displacement of the radially outer end 536e the impeller shell member 536 during the operation of the torque converter 514 of the sixth exemplary embodiment of the present invention, as best shown in FIG. 12.

The impeller wheel 530 has a radially outer end 5310 and a radially inner end 531i. As best shown in FIG. 12, the radially outer end 5310 of the impeller wheel 530 is disposed in the annular guiding groove 515 formed in in the casing 512, while the radially inner end 531i of the impeller wheel 530 is non-movably attached to the impeller hub 532 by the threaded fasteners 34, e.g. screws or bolts, or other mechanical fasteners.

The impeller core ring member 38 and the impeller blade members 40 are formed unitary with the impeller shell member 536. Specifically, according to the sixth exemplary embodiment as best shown in FIG. 13, the impeller wheel 530 is manufactured as a single-piece component by an additive manufacturing (AM) process, such as 3D printing.

According to the sixth exemplary embodiment of the present invention, the second casing shell 518 with the impeller hub 532 is made of a metallic material (or metal), such as steel, while the impeller wheel 530 is made of a polymeric material (or polymer) including technical plastics, such as polyether ether ketone (PEEK) thermoplastic polymer (an organic thermoplastic polymer in the polyaryletherketone (PAEK) family), nylon and carbon fibers (e.g., Carbon Fiber CFF™), and resins, such as PLASTCure Rigid, etc.

Moreover, the impeller shell member 536, as best shown in FIG. 13, includes a substantially annular, semi-toroidal (or concave) impeller shell portion 542 and an impeller flange portion 544, radially inwardly extending from the impeller shell portion 542. The impeller shell member 536 of the impeller wheel 530 is non-movably (i.e., fixedly) secured to the mounting flange 533_{M} of the impeller hub 532 by the threaded fasteners 34 or other mechanical fasteners extending through openings in the impeller flange portion 544 and the metal ring 35 (as best shown in FIG. 13). In other words, the impeller wheel 530, made of polymeric material, is non-movably (i.e., fixedly) secured to the impeller hub 532, made of metallic material.

The impeller wheel 530 and the turbine wheel 48 collectively define a substantially toroidal torus chamber 523 therebetween, as best shown in FIG. 12. Further referring to FIG. 12, a first chamber 5251 is to the left side of the torque converter 514, and a second chamber 5252 is to the other (right) side of the torque converter 514. In other words, the torus chamber 523 is defined within the torque converter 514, while the first chamber 5251 is defined axially between the second casing shell 518 and the impeller wheel 530 (i.e., outside the torque converter 514), and the second chamber 5252 is defined axially between the first casing shell 16 and the turbine wheel 48 (i.e., also outside the torque converter 514). Moreover, the impeller wheel 530 has a communication opening 543 fluidly connecting the torus chamber 523 with the first chamber 5251. Moreover, the guide flange 537R at the radially outer end 5310 of the impeller wheel 530 is disposed in the guiding groove 515 of the casing 512 with a gap fluidly connecting the first chamber 5251 with the second chamber 5252. According to the sixth exemplary embodiment of the present invention, the communication opening 543 is located adjacent to the radially inner end 531i of the impeller wheel 530, as best shown in FIG. 12.

A method for assembling the hydrokinetic torque-coupling device 510 is as follows. First, the turbine assembly 24 and the stator 26 of the torque converter 514 may each be preassembled, as shown in FIG. 12. The impeller wheel 530 is made of a polymeric material, such as plastic, resin, etc, by an additive manufacturing process. The polymeric materials used in making the impeller wheel 530 include technical plastics, such as PEEK, nylon and carbon fibers, and resins, such as PLASTCure Rigid, etc. Moreover, the impeller wheel 530 is manufactured as a single-piece component by an additive manufacturing process, such as SLS, SLM, FDM, SLA, etc.

Then, the second casing shell 518 formed unitarily with the impeller hub 532, such as a single-piece component made of metallic material, such as steel, is provided. Next, the impeller shell member 536 of the impeller wheel 530 is non-movably secured to the impeller hub 532 by appropriate means, such as by the screws 34 or other mechanical fasteners, while the guide flange 537R of the impeller shell member 536 is axially juxtaposed with the guiding rib 565 of the second casing shell 518, so as to form the impeller assembly 522, as best shown in FIG. 13.

Then, the impeller assembly 522, the turbine assembly 24 and the stator 26 are assembled together so as to form the torque converter 514, as best shown in FIG. 12. After that, the first casing shell 16 is sealingly fixed to the second casing shell 118 of the casing 112, such as by welding or threaded fasteners 20 or other mechanical fasteners, so that the torque converter 114 is sealed within the casing 112 and the guide flange 537R of the impeller shell member 536 is disposed between the guiding rib 565 of the second casing shell 518 and the first connector flange 17 of the first casing shell 16, as best shown in FIG. 12.

The foregoing description of the exemplary embodiments of the present invention has been presented for the purpose of illustration in accordance with the provisions of the Patent Statutes. It is not intended to be exhaustive or to limit the invention to the precise forms disclosed. The embodiments disclosed hereinabove were chosen in order to best illustrate the principles of the present invention and its practical application to thereby enable those of ordinary skill in the art to best utilize the invention in various embodiments and with various modifications as suited to the particular use contemplated, as long as the principles described herein are followed. This application is therefore intended to cover any variations, uses, or adaptations of the invention using its general principles. Further, this application is intended to cover such departures from the present disclosure as come within known or customary practice in the art to which this invention pertains. Thus, changes can be made in the above-described invention without departing from the intent and scope thereof. It is also intended that the scope of the present invention be defined by the claims appended thereto.

1. An impeller assembly (22, 122, 222, 322, 422, 522) for a hydrokinetic torque converter (14, 114, 214, 314, 414, 514), the impeller assembly (22, 122, 222, 322, 422, 522) rotatable about a rotational axis (X) and comprising:
an annular impeller wheel (30, 130, 230, 330, 430, 530) coaxial with the rotational axis (X); and
an annular impeller hub (32, 132, 232, 332, 432, 532) made of a metallic material and non-rotatably coupled to the impeller wheel (30, 130, 230, 330, 430, 530);
wherein the impeller wheel (30, 130, 230, 330, 430, 530) is made of a polymeric material as a single-piece component including an annular impeller shell member (36, 136, 236, 336, 436, 536) and a plurality of turbine blade members (40) axially inwardly extending from the impeller shell member (36, 136, 236, 336, 436, 536).

2. The impeller assembly (22, 122, 222, 322, 422, 522) as defined in claim 1, wherein the impeller shell member (36, 136, 236, 336, 436, 536) includes a semi-toroidal impeller shell portion (42, 142, 242, 342, 442, 542) and a radially extending impeller flange portion (44, 144, 244, 344, 444, 544).

3. The impeller assembly (22, 122, 422, 522) as defined in claim 1, wherein the impeller wheel (13, 130, 430, 530) is non-movably connected to the impeller hub (32, 132, 432, 532) by a mechanical fastener (34).

4. The impeller assembly (22, 122, 422, 522) as defined in claim 3, wherein the mechanical fastener is a threaded fastener (34).

5. The impeller assembly (222) as defined in claim 1, wherein a radially inner end of the impeller wheel (230) is axially biased against the impeller hub (232) by a spring member (260).

6. The impeller assembly (322) as defined in claim 1, further comprising a retention member (362) mounted in an annular groove (364) formed in the impeller hub (332) and configured to prevent axial displacement of a radially inner end (331i) of the impeller wheel (330) in the direction away from the impeller hub (332).

7. The impeller assembly (22, 122, 222, 322, 422, 522) as defined in claim 1, wherein the polymeric material is one of polyether ether ketone, nylon and carbon fibers, and resins.

8. A hydrokinetic torque converter (14, 114, 214, 314, 414, 514), comprising:
a casing (12, 112, 212, 312, 412, 512) rotatable about a rotational axis (X);
an impeller assembly (22, 122, 222, 322, 422, 522) comprising an annular impeller wheel (30, 130, 230, 330, 430, 530) non-movably attached to the casing (12, 112, 212, 312, 412, 512) and coaxial with the rotational axis (X), and an annular impeller hub (32, 132, 232, 332, 432, 532) integral with the casing (12, 112, 212, 312, 412, 512) and non-rotatably coupled to the impeller wheel (30, 130, 230, 330, 430, 530); and
a turbine assembly (24) coaxially aligned with and fluidly coupled to the impeller assembly (22, 122, 222, 322, 422, 522);
the impeller wheel (30, 130, 230, 330, 430, 530) being made of a polymeric material as a single-piece component including an annular impeller shell member (36, 136, 236, 336, 436, 536) and a plurality of turbine blade members (40) axially inwardly extending from the impeller shell member (36, 136, 236, 336, 436, 536);
the impeller hub (32, 132, 232, 332, 432, 532) being made of a metallic material.

9. The hydrokinetic torque converter (14, 114, 214, 314, 414, 514) as defined in claim 8, wherein the casing (12, 112, 212, 312, 412, 512) includes a first casing shell (16, 116, 216, 316, 416, 516) and a second casing shell (18, 118, 218, 318, 418, 518) disposed coaxially with and axially opposite to the first casing shell (16), and wherein the first and second casing shells are non-movably interconnected about outer peripheries thereof.

10. The hydrokinetic torque converter (14, 114) as defined in claim 9, wherein a radially outer end (31o, 131o) of the impeller wheel (30, 130) is non-movably attached to the first casing shell (16) by a mechanical fastener (20), and wherein a radially inner end (31i, 131i) of the impeller wheel (30, 130) is non-movably attached to the impeller hub (32, 132) by a mechanical fasteners (34).

11. The hydrokinetic torque converter (14) as defined in claim 9, wherein a portion of the second casing shell (18) of the casing (12) forms the impeller shell member (36) of the impeller wheel (30).

12. The hydrokinetic torque converter (114, 214, 314, 414, 514) as defined in claim 9, wherein the impeller wheel (130, 230, 330, 430, 530) is formed separately from the second casing shell (118, 218, 318, 418, 518) and non-movably connected to the casing (112, 212, 312, 412, 512), and wherein the impeller hub (132, 232, 332, 432, 532) is formed unitarily with the second casing shell (118, 218, 318, 418, 518) as a single-piece component.

13. The hydrokinetic torque converter (114, 414, 514) as defined in claim 9, wherein a radially inner end of the impeller wheel (130, 430, 530) is non-movably connected to the impeller hub (132, 432, 532) by a mechanical fastener.

14. The hydrokinetic torque converter (114, 214, 314) as defined in claim 9, wherein a radially outer end of the impeller wheel (130, 230, 330) is non-movably connected to the casing (112, 212, 312) by a mechanical fastener.

15. The hydrokinetic torque converter (214) as defined in claim 14, wherein a radially inner end of the impeller wheel (230) is axially biased against the impeller hub (232) by a spring member (260).

16. The hydrokinetic torque converter (314) as defined in claim 14, wherein the impeller assembly (322) further comprises a retention member (362) mounted in an annular groove (364) formed in the impeller hub (332) and configured to prevent axial displacement of a radially inner end of the impeller wheel (330) in the direction away from the second casing shell (318).

17. The hydrokinetic torque converter (414) as defined in claim 8, wherein a radially outer end of the impeller wheel (430) is radially spaced from the second casing shell (418).

18. The hydrokinetic torque converter (514) as defined in claim 8, wherein a radially outer end of the impeller wheel (530) is disposed in an annular guiding groove (515) formed in in the casing (512).

19. The hydrokinetic torque converter (14, 114, 214, 314, 414, 514) as defined in claim 8, wherein the polymeric material is one of polyether ether ketone, nylon and carbon fibers, and resins.

20. A method for manufacturing an impeller assembly (22, 122, 222, 322, 422, 522) of a hydrokinetic torque converter (14, 114, 214, 314, 414, 514), the method comprising the steps of:
providing an impeller hub (32, 132, 232, 332, 432, 532) made of a metallic material;
providing an impeller wheel (30, 130, 230, 330, 430, 530) manufactured by an additive manufacturing process as a single-piece component from a polymeric material, including the steps of
sequentially depositing a plurality of successive layers of the polymeric material in a configured pattern corresponding to the shape of the impeller wheel (30, 130, 230, 330, 430, 530) including an annular impeller shell member (36, 136, 236, 336, 436, 536) and a plurality of impeller blade members (40) unitarily formed with the impeller shell member (36, 136, 236, 336, 436, 536) and axially extending from the impeller shell member (36, 136, 236, 336, 436, 536); and
selectively fusing each layer prior to deposition of the subsequent layer so as to form the impeller wheel (30, 130, 230, 330, 430, 530); and
non-rotatably coupling the impeller wheel (30, 130, 230, 330, 430, 530) to the impeller hub (32, 132, 232, 332, 432, 532).

21. The method as defined in claim 20, wherein the step of non-rotatably coupling the impeller hub (32, 132, 432, 532) to the impeller wheel (30, 130, 430, 530) includes the step of non-movably connecting the impeller wheel (13, 130, 430, 530) to the impeller hub (32, 132, 432, 532) by a mechanical fastener (34).

22. The method as defined in claim 20, further including the steps of:
providing a spring member (260) and a retention member (262);
placing the impeller wheel (230) to the impeller hub (232);
placing the spring member (260) to the impeller hub (232) so that the impeller wheel (230) is disposed between the impeller hub (232) and the spring member (260);
compressing the spring member (260); and
mounting the retention member (262) to the impeller hub (232) next to the spring member (260) so as to retain the spring member (260) on the impeller hub (232) for biasing the impeller wheel (230) against the impeller hub (232).

23. The method as defined in claim 20, further including the steps of:
providing a retention member (362);
placing the impeller wheel (330) to the impeller hub (332); and
mounting the retention member (362) to the impeller hub (332) so that the impeller wheel (330) is disposed between the impeller hub (332) and the retention member (362) so as to prevent axial displacement of the impeller wheel (330) in the axial direction away from the impeller hub (332).

24. The method as defined in claim 20, wherein the polymeric material is one of polyether ether ketone, nylon and carbon fibers, and resins.

25. The method as defined in claim 20, wherein the additive manufacturing process is one of selective laser sintering, selective laser melting, fused deposition modeling, and stereolithography.
